(19) United States
(12) Patent Application Publication
(10) Pub. No.: US 2026/0343205 A1
(43) Pub. Date: Oct. 29, 2026

(54) MANAGING INFORMATION EXCHANGE

(71) Applicant: Telefonaktiebolaget LM Ericsson (publ), Stockholm (SE)

(72) Inventors: Maria Cruz BARTOLOME RODRIGO, Madrid (ES); Volker KLEINFELD, Aachen (DE); Mary Amarisa ROBISON PIETSCH, Aachen (DE)

(73) Assignee: Telefonaktiebolaget LM Ericsson (publ), Stockholm (SE)

(21) Appl. No.: 19/483,891

(22) PCT Filed: May 2, 2024
(86) PCT No.: PCT/EP2024/062164

§ 371 Date: Nov. 12, 2025

(30) Foreign Application Priority Data
May 12, 2023 (EP) 23382448.1

(51) Int. Cl. H04W 8/12; H04W 8/00

(52) U.S. Cl. CPC H04W 8/12; H04W 8/005

(57) ABSTRACT

There is provided a method for managing information exchange between networks. The method is performed by a first network repository function (NRF) node. The method comprises providing information to a second NRF node. A visited network of a first network function (NF) node comprises the second NRF node and a home network of the first NF node comprises the first NRF node. The information is indicative of whether the home network is capable of performing a task delegated to the home network from the visited network.

### TECHNICAL FIELD

The disclosure relates to methods for managing information exchange between networks and nodes configured to operate in accordance with those methods.

### BACKGROUND

There exist various techniques for handling a request for a service in a network. A service request is generally from a consumer of the service (“service consumer”) to a producer of the service (“service producer”). For example, a service request may be from a network function (NF) node of a service consumer to an NF node of a service producer. The NF node of the service consumer and the NF node of the service producer can communicate directly or indirectly. This is referred to as direct communication and indirect communication respectively. In the case of indirect communication, the NF node of the service consumer and the NF node of the service producer may communicate via a service communication proxy (SCP) node.

FIG. 1A-D illustrates different existing systems for handling service requests, as set out in the Third Generation Partnership Project (3GPP) Technical Specification (TS) 23.501 Version (V) 17.3.0. In more detail, FIGS. 1A and 1B illustrate systems that use direct communication, while FIGS. 1C and 1D illustrate systems that use indirect communication. FIGS. 1A, 1B, 1C and 1D can be said to represent Models A, B, C and D respectively, which may be referenced herein.

In the systems illustrated in FIGS. 1A and 1B, a service request is sent directly from the NF node of the service consumer to the NF node of the service producer. A response to the service request is sent directly from the NF node of the service producer to the NF node of the service consumer. Similarly, any subsequent service requests are sent directly from the NF node of the service consumer to the NF node of the service producer. The system illustrated in FIG. 1B also comprises a network repository function (NRF) node. Thus, in the system illustrated in FIG. 1B, the NF node of the service consumer can query the NRF node to discover suitable NF nodes of the service producer to which to send the service request. In response to such a query, the NF node of the service consumer can receive an NF profile for one or more NF nodes of the service producer and, based on the received NF profile(s), can select an NF node of the service producer to which to send the service request. In the system illustrated in FIG. 1A, the NRF node is not used and instead the NF node of the service consumer may be configured with the NF profile(s) of the NF node(s) of the service producer.

In the systems illustrated in FIGS. 1C and 1D, a service request is sent indirectly from the NF node of the service consumer to the NF node of the service producer via a service communication proxy (SCP) node. A response to the service request is sent indirectly from the NF node of the service producer to the NF node of the service consumer via the SCP node. Similarly, any subsequent service requests are sent indirectly from the NF node of the service consumer to the NF node of the service producer via the SCP node. The systems illustrated in FIGS. 1C and 1D also comprise an NRF node.

In the system illustrated in FIG. 1C, the NF node of the service consumer can query the NRF node to discover suitable NF nodes of the service producer to which to send the service request. In response to such a query, the NF node of the service consumer can receive an NF profile for one or more NF nodes of the service producer and, based on the received NF profile(s), can select an NF node of the service producer to which to send the service request. In this case, the service request sent from the NF node of the service consumer to the SCP node comprises the address of the selected NF node of the service producer. The NF node of the service consumer can forward the service request without performing any further discovery or selection. In case the selected NF node of the service producer is not accessible for any reason, it may be up to the NF node of the service consumer to find an alternative. In other cases, the SCP node may communicate with the NRF node to acquire selection parameters (e.g. location, capacity, etc.) and the SCP node may select an NF node of the service producer to which to send the service request.

In the system illustrated in FIG. 1D, the NF node of the service consumer does not carry out the discovery or selection process. Instead, the NF node of the service consumer adds any necessary discovery and selection parameters (required to find a suitable NF node of the service producer) to the service request that it sends via the SCP node. The SCP node uses the request address and the discovery and selection parameters in the service request to route the service request to a suitable NF node of the service producer. Thus, in the system illustrated in FIG. 1D, where indirect communication with delegated discovery is used, the NF node of the service consumer sends the service request to the SCP node and provides, within the service request to the SCP node, the discovery and selection parameters necessary to discover and select an NF node of a service producer. The SCP node can perform discovery with the NRF node to discover a target NF node of the service producer to which to route the service request. The SCP node can discover a target NF node of the service producer in the manner indicated in 3GPP TS 23.502V 17.3.0 .

For the fifth generation core (5GC), from Release 16, the SCP node is included as a network element to allow indirect communication between an NF node of a service consumer and an NF node of a service producer. That is, the SCP node can be used in indirect routing scenarios, as described earlier with reference to FIGS. 1C and 1D.

### SUMMARY

As described earlier, indirect communication from a first NF (e.g. NF consumer, NFc) node to a second NF (e.g. NF producer, NFp) node via a first SCP node is defined in 3GPP at Stage 2 level. Indirect communication provides the means for a first NF node to be able to delegate all, or part, of the logic required for initial selection of the required second NF node and/or for reselection of an alternative second NF node (e.g. in case of failure of the initially selection second NF node) to the SCP.

However, while delegating (re)selection logic has some advantages, an issue exists in that Stage 2 does not consider any requirements for indirect communication (e.g. the model illustrated in FIG. 1C) across public land mobile networks (PLMNs). Apart from that, in general, delegation of (re)selection of NF logic from a visited network (e.g. a visited public land mobile network, vPLMN) to a home network (e.g. a home public land mobile network, hPLMN) means that the information required for (re)selection of NF(s) is provided from the visited network to the home network. However, an issue arises in that the home network may not be able to support the required delegation of logic and this will cause an error.

It is an object of the disclosure to obviate or eliminate at least some of the above-described disadvantages associated with existing techniques.

Therefore, according to an aspect of the disclosure, there is provided a first method for managing information exchange between networks. The first method is performed by a first network repository function (NRF) node. The first method comprises providing information to a second NRF node. A visited network of a first network function (NF) node comprises the second NRF node and a home network of the first NF node comprises the first NRF node. The information is indicative of whether the home network is capable of performing a task delegated to the home network from the visited network.

According to another aspect of the disclosure, there is provided a second method for managing information exchange between networks. The second method is performed by a first NRF node. The second method comprises acquiring information from a memory of the first NRF node or from a second network node. The second network node is a second NF node or a first security edge protection proxy (SEPP) node. A home network of a first NF node comprises the second network node and the first NRF node. The information is indicative of whether the home network is capable of performing a task delegated to the home network from a visited network of the first NF node.

According to another aspect of the disclosure, there is also provided a first NRF node comprising processing circuitry configured to operate in accordance with one or both of the first method and the second method. In some embodiments, the first NRF node may comprise at least one memory for storing instructions which, when executed by the processing circuitry, cause the first NRF node to operate in accordance with one or both of the first method and the second method.

According to another aspect of the disclosure, there is provided a third method for managing information exchange between networks. The third method is performed by a second NRF node. The third method comprises acquiring information from a first NRF node. A home network of a first NF node comprises the first NRF node and a visited network of the first NF node comprises the second NRF node. The information is indicative of whether the home network is capable of performing a task delegated to the home network from the visited network.

According to another aspect of the disclosure, there is provided a fourth method for managing information exchange between networks. The fourth method is performed by a second NRF node. The fourth method comprises providing information to a first network node. The first network node is a first NF node or a first service communication proxy (SCP) node that is configured to operate as an SCP between the first NF node and the second NRF node. A visited network of the first NF node comprises the second NRF node and the first network node. The information is indicative of whether a home network of the first NF node is capable of performing a task delegated to the home network from the visited network.

According to another aspect of the disclosure, there is also provided a second NRF node comprising processing circuitry configured to operate in accordance with one or both of the third method and the fourth method. In some embodiments, the second NRF node may comprise at least one memory for storing instructions which, when executed by the processing circuitry, cause the second NRF node to operate in accordance with one or both of the third method and the fourth method.

According to another aspect of the disclosure, there is provided a fifth method for managing information exchange between networks. The fifth method is performed by a first network node. The fifth method comprises acquiring information from a second NRF node. The first network node is a first NF node or a first SCP node that is configured to operate as an SCP between the first NF node and the second NRF node. A visited network of the first NF node comprises the second NRF node and the first network node. The information is indicative of whether a home network of the first NF node is capable of performing a task delegated to the home network from the visited network.

According to another aspect of the disclosure, there is also provided a first network node comprising processing circuitry configured to operate in accordance with the fifth method. In some embodiments, the first network node may comprise at least one memory for storing instructions which, when executed by the processing circuitry, cause the first network node to operate in accordance with the fifth method.

According to another aspect of the disclosure, there is provided a sixth method for managing information exchange between networks. The sixth method is performed by a second network node. The sixth method comprises providing information to a first NRF node. The second network node is a second NF node or a first security edge protection proxy (SEPP) node. A home network of a first NF node comprises the second network node and the first NRF node. The information is indicative of whether the home network is capable of performing a task delegated to the home network from a visited network of the first NF node.

According to another aspect of the disclosure, there is also provided a second network node comprising processing circuitry configured to operate in accordance with the sixth method. In some embodiments, the second network node may comprise at least one memory for storing instructions which, when executed by the processing circuitry, cause the second network node to operate in accordance with the sixth method.

According to another aspect of the disclosure, there is provided a method performed by a system. The method comprises any two or more of the first, second, third, fourth, fifth and sixth methods.

According to another aspect of the disclosure, there is provided a system comprising any two or more of a first NRF node as described earlier, a second NRF node as described earlier, a first network node as described earlier, and a second network node as described earlier.

According to another aspect of the disclosure, there is provided a computer program comprising instructions which, when executed by processing circuitry, cause the processing circuitry to perform any one or more of the first, second, third, fourth, fifth and sixth methods.

According to another aspect of the disclosure, there is provided a computer program product, embodied on a non-transitory machine-readable medium, comprising instructions which are executable by processing circuitry to cause the processing circuitry to perform any one or more of the first, second, third, fourth, fifth and sixth methods.

Thus, in the manner described, advantageous information sharing is employed that provides the nodes of the network with knowledge needed to avoid useless signalling and processing. The nodes of the network are provided with the knowledge of whether or not the home network is capable of performing a task delegated to the home network. More specifically, the information sharing enables the first network node to be informed about the home network capabilities to perform a task, such as a (re)selection of NFs. This information can be used by the visited network to delegate a task in such a way that useless signalling and processing can be avoided. For example, the visited network can make use of the information to avoid delegating the task to the home network when the home network is not able to process it, or alternatively delegate the task to the SEPP node of the visited network or an SCP node at the border (or edge) of the visited network.

Therefore, there is provided an improved technique for managing information exchange between networks.

### BRIEF DESCRIPTION OF THE DRAWINGS

For a better understanding of the technique, and to show how it may be put into effect, reference will now be made, by way of example, to the accompanying drawings, in which:

FIG. 1A-D is a block diagram illustrating different existing systems;

FIG. 2 is a block diagram illustrating a first NRF node according to an embodiment;

FIGS. 3 and 4 are block diagrams illustrating methods performed by a first NRF node according to an embodiment;

FIG. 5 is a block diagram illustrating a second NRF node according to an embodiment;

FIGS. 6 and 7 are block diagrams illustrating methods performed by a second NRF node according to an embodiment;

FIG. 8 is a block diagram illustrating a first network node according to an embodiment;

FIG. 9 is a block diagram illustrating a method performed by a first network node according to an embodiment;

FIG. 10 is a block diagram illustrating a second network node according to an embodiment;

FIG. 11 is a block diagram illustrating a method performed by a second network node according to an embodiment;

FIG. 12 is a block diagram illustrating a system according to an example;

FIGS. 13 and 14 are signalling diagrams illustrating an exchange of signals in an example system; and

FIGS. 15 to 24 are signalling diagrams illustrating an exchange of signals in a system according to an embodiment.

### DETAILED DESCRIPTION

Some of the embodiments contemplated herein will now be described more fully with reference to the accompanying drawings. Other embodiments, however, are contained within the scope of the subject-matter disclosed herein, the disclosed subject-matter should not be construed as limited to only the embodiments set forth herein; rather, these embodiments are provided by way of example to convey the scope of the subject-matter to those skilled in the art.

Herein, techniques for handling a service request in a network are described. A service request can also be referred to as a request for a service. Generally, a service is software intended to be managed for users. Herein, a service can be any type of service, such as a communication service (e.g. a notification service or a callback service), a context management (e.g. user equipment context management (UECM)) service, a data management (DM) service, or any other type of service. Herein, references to providing a service can refer to, for example, executing or running the service.

Herein, techniques for handling a notification request in a network are also described. A notification request can also be referred to as a request for a notification. Generally, users can subscribe to receive a notification. Herein, a notification can be any type of notification, such as an event notification (such as an event occurrence notification, e.g. to report an event), an update notification (e.g. to report an update), a monitoring revocation notification, a unified data repository (UDR)-initiated data restoration notification, an N1 notification, or any other type of notification. Herein, references to providing a notification can refer to, for example, sending the notification.

Herein, the term “initiate” can mean, for example, cause or establish. Thus, any reference to a node “initiating transmission” will be understood to mean that the node (e.g. processing circuitry of the node) can be configured to itself transmit (e.g. via a communications interface of the node) or can be configured to cause another node to transmit.

The techniques described herein can be used in respect of any network, such as any communications or telecommunications network, e.g. cellular network. The network may be a fifth generation (5G) network or any other generation network. In some embodiments, the network may be a core network or a radio access network (RAN). The techniques refer to a home network and a visited network. The home network referred to herein can, for example, be a home public land mobile network (PLMN), i.e. a h-PLMN. Similarly, the visited network referred to herein can, for example, be a visited PLMN, i.e. a v-PLMN.

The techniques described herein are implemented by a first network repository function (NRF) node, a second NRF node, a first network node, and a second network node. The first network node can, for example, be a first network function (NF) node or a first service communication proxy (SCP) node. The first SCP node is a node that is configured to operate as an SCP between the first NF node and the second NRF node. The second network node can, for example, be a second NF node or a first security edge protection proxy (SEPP) node.

An NF is a third generation partnership project (3GPP) adopted, or 3GPP defined, processing function in a network, which has defined functional behaviour and 3GPP defined interfaces. An NF can be implemented either as a network element on a dedicated hardware, as a software instance running on a dedicated hardware, or as a virtualised function instantiated on an appropriate platform, e.g. on a cloud infrastructure. Herein, the term “node” in relation to an “NF node” will be understood to cover each of these scenarios. Herein, references to an NF node may refer to, for example, an instance of an NF node and, similarly, references to a plurality of NF nodes may refer to (for example, functionally equivalent) instances of NF nodes. Thus, the terms “NF” and “NF instance” may be used interchangeably.

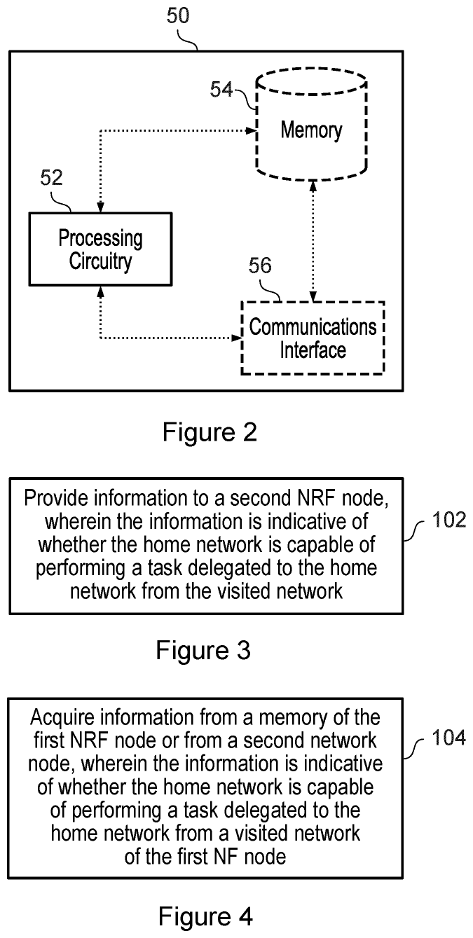

FIG. 2 illustrates a first NRF node 50 of a home network of a first NF node in accordance with an embodiment. The first NRF node 50 is for managing information exchange between networks. In some embodiments, the first NRF node 50 referred to herein can refer to equipment capable, configured, arranged and/or operable to communicate directly or indirectly with the second NRF node referred to herein, the second network node referred to herein, and/or with other nodes or equipment to enable and/or to perform the functionality described herein. In some embodiments, the first NRF node 50 referred to herein can, for example, be a physical node (e.g. a physical machine or server) or a virtual node (e.g. a virtual machine, VM).

As illustrated in FIG. 2, the first NRF node 50 comprises processing circuitry (or logic) 52. The processing circuitry 52 controls the operation of the first NRF node 50 and can implement the method described herein in respect of the first NRF node 50. The processing circuitry 52 can be configured or programmed to control the first NRF node 50 in the manner described herein. The processing circuitry 52 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the first NRF node 50. In some embodiments, the processing circuitry 52 can be configured to run software to perform the method described herein in respect of the first NRF node 50. The software may be containerised according to some embodiments. Thus, in some embodiments, the processing circuitry 52 may be configured to run a container to perform the method described herein in respect of the first NRF node 50.

Briefly, the processing circuitry 52 of the first NRF node 50 is configured to provide information to a second NRF node. A visited network of a first NF node comprises the second NRF node and a home network of the first NF node comprises the first NRF node 50. The information is indicative of whether the home network is capable of performing a task delegated to the home network from the visited network.

Alternatively or in addition, the processing circuitry 52 of the first NRF node 50 is configured to acquire information from a memory of the first NRF node 50 or from a second network node. The second network node is a second NF node or a first security edge protection proxy (SEPP) node. A home network of a first NF node comprises the second network node and the first NRF node 50. The information is indicative of whether the home network is capable of performing a task delegated to the home network from a visited network of the first NF node.

As illustrated in FIG. 2, in some embodiments, the first NRF node 50 may optionally comprise a memory 54. The memory 54 of the first NRF node 50 can comprise a volatile memory or a non-volatile memory. In some embodiments, the memory 54 of the first NRF node 50 may comprise a non-transitory media. Examples of the memory 54 of the first NRF node 50 include, but are not limited to, a random access memory (RAM), a read only memory (ROM), a mass storage media such as a hard disk, a removable storage media such as a compact disk (CD) or a digital versatile disk (DVD), and/or any other memory.

The processing circuitry 52 of the first NRF node 50 can be communicatively coupled (e.g. connected) to the memory 54 of the first NRF node 50. In some embodiments, the memory 54 of the first NRF node 50 may be for storing program code or instructions which, when executed by the processing circuitry 52 of the first NRF node 50, cause the first NRF node 50 to operate in the manner described herein in respect of the first NRF node 50. For example, in some embodiments, the memory 54 of the first NRF node 50 may be configured to store program code or instructions that can be executed by the processing circuitry 52 of the first NRF node 50 to cause the first NRF node 50 to operate in accordance with the method described herein in respect of the first NRF node 50. Alternatively or in addition, the memory 54 of the first NRF node 50 can be configured to store any information, data, messages, requests, responses, indications, notifications, signals, or similar, that are described herein. The processing circuitry 52 of the first NRF node 50 may be configured to control the memory 54 of the first NRF node 50 to store any of the information, data, messages, requests, responses, indications, notifications, signals, or similar, that are described herein.

In some embodiments, as illustrated in FIG. 2, the first NRF node 50 may optionally comprise a communications interface 56. The communications interface 56 of the first NRF node 50 can be communicatively coupled (e.g. connected) to the processing circuitry 52 of the first NRF node 50 and/or the memory 54 of the first NRF node 50. The communications interface 56 of the first NRF node 50 may be operable to allow the processing circuitry 52 of the first NRF node 50 to communicate with the memory 54 of the first NRF node 50 and/or vice versa. Similarly, the communications interface 56 of the first NRF node 50 may be operable to allow the processing circuitry 52 of the first NRF node 50 to communicate with any one or more nodes (e.g. the second NRF node referred to herein, and/or the second network node referred to herein) and/or any other node. The communications interface 56 of the first NRF node 50 can be configured to transmit and/or receive any of the information, data, messages, requests, responses, indications, notifications, signals, or similar, that are described herein. In some embodiments, the processing circuitry 52 of the first NRF node 50 may be configured to control the communications interface 56 of the first NRF node 50 to transmit and/or receive any of the information, data, messages, requests, responses, indications, notifications, signals, or similar, that are described herein.

Although the first NRF node 50 is illustrated in FIG. 2 as comprising a single memory 54, it will be appreciated that the first NRF node 50 may comprise at least one memory (i.e. a single memory or a plurality of memories) 54 that operate in the manner described herein. Similarly, although the first NRF node 50 is illustrated in FIG. 2 as comprising a single communications interface 56, it will be appreciated that the first NRF node 50 may comprise at least one communications interface (i.e. a single communications interface or a plurality of communications interfaces) 56 that operate in the manner described herein. It will also be appreciated that FIG. 2 only shows the components required to illustrate an embodiment of the first NRF node 50 and, in practical implementations, the first NRF node 50 may comprise additional or alternative components to those shown.

FIG. 3 illustrates a first method performed by a first NRF node 50 of a home network of a first NF node in accordance with an embodiment. The first method is for managing information exchange between networks. The first NRF node 50 described earlier with reference to FIG. 2 can be configured to operate in accordance with the first method of FIG. 3. The first method can be performed by or under the control of the processing circuitry 52 of the first NRF node 50 according to some embodiments.

With reference to FIG. 3, as illustrated at block 102, information is provided to a second NRF node. A visited network of a first NF node comprises the second NRF node and a home network of the first NF node comprises the first NRF node 50. The information is indicative of whether the home network is capable of performing a task delegated to the home network from the visited network.

In some embodiments, the information may be provided in response to receiving a first message from the second NRF node. In some embodiments, the first message may comprise a first request that is a request for the information and/or a second request that is a request to discover one or more second NF nodes of the home network. In some embodiments, the first message may comprise an identifier (e.g. plmn-id) that identifies the visited network. In some embodiments, providing the information to the second NRF node may comprises initiating transmission of a second message towards the second NRF node, wherein the second message comprises the information. In some embodiments, the information may be provided in a profile of a second NF node of the home network or a profile of a first SEPP node of the home network.

In some embodiments, the first method may comprise storing the information (e.g. in a memory 54) at the first NRF node 50.

In some embodiments, the first NF node may be an NF node of a consumer or the first NF node may be an NF node of a producer. In some embodiments, the task may be to select one or more second NF nodes of the home network. In some embodiments, the first NF node may be an NF node of a consumer and the task may be to select one or more second NF nodes of a producer to provide a service requested by the first NF node. In other embodiments, the first NF node may be an NF node of a producer and the task may be to select one or more second NF nodes of a consumer to provide a notification requested by the first NF node.

FIG. 4 illustrates a second method performed by a first NRF node 50 of a home network of a first NF node in accordance with an embodiment. The second method is for managing information exchange between networks. The first NRF node 50 described earlier with reference to FIG. 2 can be configured to operate in accordance with the second method of FIG. 4. The second method can be performed by or under the control of the processing circuitry 52 of the first NRF node 50 according to some embodiments.

With reference to FIG. 4, as illustrated at block 104, information is acquired from a memory of the first NRF node 50 or from a second network node. The second network node is a second NF node or a first SEPP node. A home network of a first NF comprises the second network node and the first NRF node 50. The information is indicative of whether the home network is capable of performing a task delegated to the home network from a visited network of the first NF node.

In some embodiments, acquiring the information may comprise receiving the information. In some embodiments, the information may be acquired in a profile of the second network node. In some embodiments, the information may be acquired from the second network node with a request to register the profile at the first NRF node 50.

In some embodiments, the second method may comprise storing the information (e.g. in a memory 54) at the first NRF node 50.

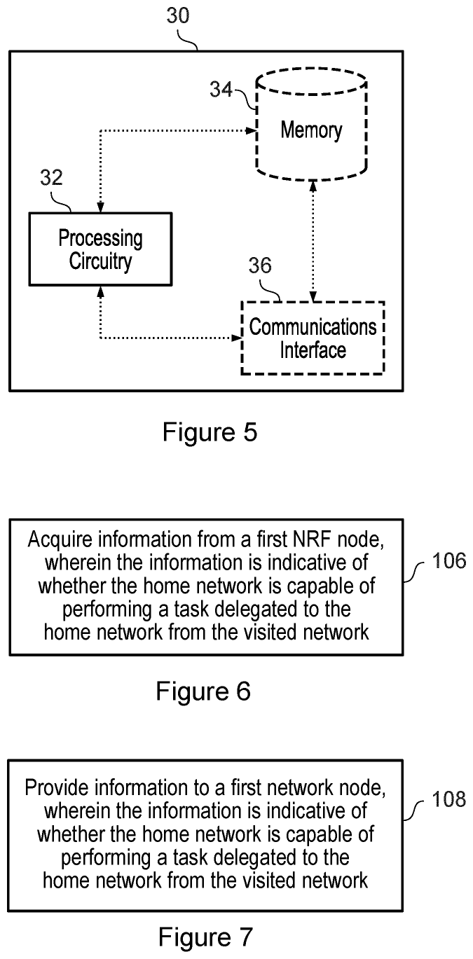

FIG. 5 illustrates a second NRF node 30 of a visited network of a first NF node in accordance with an embodiment. The second NRF node 30 is for managing information exchange between networks. In some embodiments, the second NRF node 30 referred to herein can refer to equipment capable, configured, arranged and/or operable to communicate directly or indirectly with the first NRF node 50 referred to herein, the first network node referred to herein, and/or with other nodes or equipment to enable and/or to perform the functionality described herein. In some embodiments, the second NRF node 30 referred to herein can, for example, be a physical node (e.g. a physical machine or server) or a virtual node (e.g. a virtual machine, VM).

As illustrated in FIG. 5, the second NRF node 30 comprises processing circuitry (or logic) 32. The processing circuitry 32 controls the operation of the second NRF node 30 and can implement the method described herein in respect of the second NRF node 30. The processing circuitry 32 can be configured or programmed to control the second NRF node 30 in the manner described herein. The processing circuitry 32 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the second NRF node 30. In some embodiments, the processing circuitry 32 can be configured to run software to perform the method described herein in respect of the second NRF node 30. The software may be containerised according to some embodiments. Thus, in some embodiments, the processing circuitry 32 may be configured to run a container to perform the method described herein in respect of the second NRF node 30.

Briefly, the processing circuitry 32 of the second NRF node 30 is configured to acquire information from a first NRF node 50. A home network of a first NF node comprises the first NRF node 50 and a visited network of the first NF node comprises the second NRF node 30. The information is indicative of whether the home network is capable of performing a task delegated to the home network from the visited network.

Alternatively or in addition, the processing circuitry 32 of the second NRF node 30 is configured to provide information to a first network node. The first network node is a first NF node or a first SCP node that is configured to operate as an SCP between the first NF node and the second NRF node 30. A visited network of the first NF node comprises the second NRF node 30 and the first network node. The information is indicative of whether a home network of the first NF node is capable of performing a task delegated to the home network from the visited network.

As illustrated in FIG. 5, in some embodiments, the second NRF node 30 may optionally comprise a memory 34. The memory 34 of the second NRF node 30 can comprise a volatile memory or a non-volatile memory. In some embodiments, the memory 34 of the second NRF node 30 may comprise a non-transitory media. Examples of the memory 34 of the second NRF node 30 include, but are not limited to, a random access memory (RAM), a read only memory (ROM), a mass storage media such as a hard disk, a removable storage media such as a compact disk (CD) or a digital versatile disk (DVD), and/or any other memory.

The processing circuitry 32 of the second NRF node 30 can be communicatively coupled (e.g. connected) to the memory 34 of the second NRF node 30. In some embodiments, the memory 34 of the second NRF node 30 may be for storing program code or instructions which, when executed by the processing circuitry 32 of the second NRF node 30, cause the second NRF node 30 to operate in the manner described herein in respect of the second NRF node 30. For example, in some embodiments, the memory 34 of the second NRF node 30 may be configured to store program code or instructions that can be executed by the processing circuitry 32 of the second NRF node 30 to cause the second NRF node 30 to operate in accordance with the method described herein in respect of the second NRF node 30. Alternatively or in addition, the memory 34 of the second NRF node 30 can be configured to store any information, data, messages, requests, responses, indications, notifications, signals, or similar, that are described herein. The processing circuitry 32 of the second NRF node 30 may be configured to control the memory 34 of the second NRF node 30 to store any of the information, data, messages, requests, responses, indications, notifications, signals, or similar, that are described herein.

In some embodiments, as illustrated in FIG. 5, the second NRF node 30 may optionally comprise a communications interface 36. The communications interface 36 of the second NRF node 30 can be communicatively coupled (e.g. connected) to the processing circuitry 32 of the second NRF node 30 and/or the memory 34 of the second NRF node 30. The communications interface 36 of the second NRF node 30 may be operable to allow the processing circuitry 32 of the second NRF node 30 to communicate with the memory 34 of the second NRF node 30 and/or vice versa. Similarly, the communications interface 36 of the second NRF node 30 may be operable to allow the processing circuitry 32 of the second NRF node 30 to communicate with any one or more nodes (e.g. the first NRF node 50 referred to herein, and/or the first network node referred to herein) and/or any other node. The communications interface 36 of the second NRF node 30 can be configured to transmit and/or receive any of the information, data, messages, requests, responses, indications, notifications, signals, or similar, that are described herein. In some embodiments, the processing circuitry 32 of the second NRF node 30 may be configured to control the communications interface 36 of the second NRF node 30 to transmit and/or receive any of the information, data, messages, requests, responses, indications, notifications, signals, or similar, that are described herein.

Although the second NRF node 30 is illustrated in FIG. 5 as comprising a single memory 34, it will be appreciated that the second NRF node 30 may comprise at least one memory (i.e. a single memory or a plurality of memories) 34 that operate in the manner described herein. Similarly, although the second NRF node 30 is illustrated in FIG. 5 as comprising a single communications interface 36, it will be appreciated that the second NRF node 30 may comprise at least one communications interface (i.e. a single communications interface or a plurality of communications interfaces) 36 that operate in the manner described herein. It will also be appreciated that FIG. 5 only shows the components required to illustrate an embodiment of the second NRF node 30 and, in practical implementations, the second NRF node 30 may comprise additional or alternative components to those shown.

FIG. 6 illustrates a third method performed by a second NRF node 30 of a visited network of a first NF node in accordance with an embodiment. The third method is for managing information exchange between networks. The second NRF node 30 described earlier with reference to FIG. 5 can be configured to operate in accordance with the third method of FIG. 6. The third method can be performed by or under the control of the processing circuitry 32 of the second NRF node 30 according to some embodiments.

With reference to FIG. 6, as illustrated at block 106, information is acquired from a first NRF node 50. A home network of a first NF node comprises the first NRF node 50 and a visited network of the first NF node comprises the second NRF node 30. The information is indicative of whether the home network is capable of performing a task delegated to the home network from the visited network.

In some embodiments, the information may be acquired in response to transmitting a first message towards the first NRF node 50. In some embodiments, the first message may comprise a first request that is a request for the information and/or a second request that is a request to discover one or more second NF nodes of the home network. In some embodiments, the first message may comprise an identifier that identifies the visited network.

In some embodiments, acquiring the information from the first NRF node 50 may comprise receiving a second message from the first NRF node 50, wherein the second message comprises the information. In some embodiments, the information may be acquired in a profile of a second NF node of the home network or a profile of a first SEPP node of the home network.

FIG. 7 illustrates a fourth method performed by a second NRF node 30 of a visited network of a first NF node in accordance with an embodiment. The fourth method is for managing information exchange between networks. The second NRF node 30 described earlier with reference to FIG. 5 can be configured to operate in accordance with the fourth method of FIG. 7. The fourth method can be performed by or under the control of the processing circuitry 32 of the second NRF node 30 according to some embodiments.

With reference to FIG. 7, as illustrated at block 108, information is provided to a first network node. The first network node is a first NF node or a first SCP node that is configured to operate as an SCP between the first NF node and the second NRF node 30. A visited network of the first NF node comprises the second NRF node 30 and the first network node. The information is indicative of whether a home network of the first NF node is capable of performing a task delegated to the home network from the visited network.

In some embodiments, the information may be provided in response to receiving a second message from a first NRF node 50, wherein the second message comprises the information. In some embodiments, providing the information to the first network node may comprise initiating transmission of a third message towards the first network node, wherein the third message comprises the information. In some embodiments, the information may be provided in a profile of a second NF node of the home network or a profile of a first SEPP node of the home network.

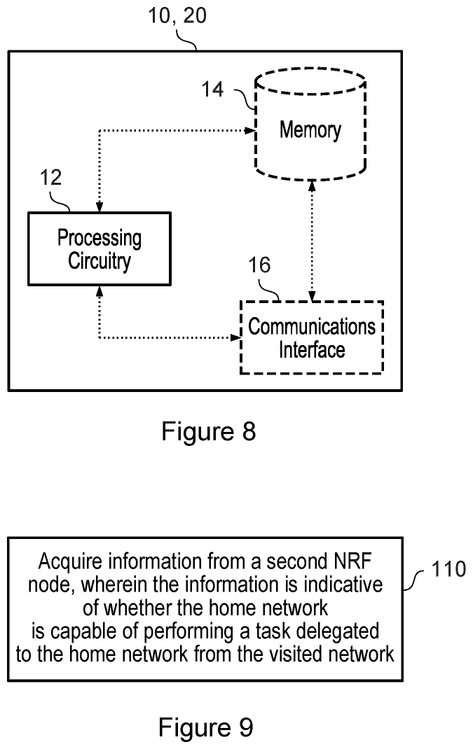

FIG. 8 illustrates a first network node 10, 20 of a visited network of a first NF node in accordance with an embodiment. The first network node 10, 20 is for managing information exchange between networks.

As mentioned earlier, in some embodiments, the first network node 10, 20 may be the first NF node 10 or a first SCP node 20. The first SCP node 20 can be a node that is configured to operate as an SCP between the first NF node 10 and the second NRF node 30. In some embodiments, the first NF node 10 referred to herein can be a wireless device, e.g. a user equipment (UE). In some embodiments, the first network node 10, 20 referred to herein can refer to equipment capable, configured, arranged and/or operable to communicate directly or indirectly with the second NRF node 30 referred to herein, the first NF node 10 referred to herein (in embodiments where the first network node is the first SCP node 20), the first SCP node 20 referred to herein (in embodiments where the first network node is the first NF node 10) and/or with other nodes or equipment to enable and/or to perform the functionality described herein. In some embodiments, the first network node 10, 20 referred to herein can, for example, be a physical node (e.g. a physical machine or server) or a virtual node (e.g. a virtual machine, VM).

As illustrated in FIG. 8, the first network node 10, 20 comprises processing circuitry (or logic) 12. The processing circuitry 12 controls the operation of the first network node 10, 20 and can implement the method described herein in respect of the first network node 10, 20. The processing circuitry 12 can be configured or programmed to control the first network node 10, 20 in the manner described herein. The processing circuitry 12 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the first network node 10, 20. In some embodiments, the processing circuitry 12 can be configured to run software to perform the method described herein in respect of the first network node 10, 20. The software may be containerised according to some embodiments. Thus, in some embodiments, the processing circuitry 12 may be configured to run a container to perform the method described herein in respect of the first network node 10, 20.

Briefly, the processing circuitry 12 of the first network node 10, 20 is configured to acquire information from a second NRF node 30. The first network node 10, 20 is a first NF node 10 or a first SCP node 20 that is configured to operate as an SCP between the first NF node 10 and the second NRF node 30. A visited network of the first NF node 10 comprises the second NRF node 30 and the first network node 10, 20. The information is indicative of whether a home network of the first NF node 10 is capable of performing a task delegated to the home network from the visited network.

As illustrated in FIG. 8, in some embodiments, the first network node 10, 20 may optionally comprise a memory 14. The memory 14 of the first network node 10, 20 can comprise a volatile memory or a non-volatile memory. In some embodiments, the memory 14 of the first network node 10, 20 may comprise a non-transitory media. Examples of the memory 14 of the first network node 10, 20 include, but are not limited to, a random access memory (RAM), a read only memory (ROM), a mass storage media such as a hard disk, a removable storage media such as a compact disk (CD) or a digital versatile disk (DVD), and/or any other memory.

The processing circuitry 12 of the first network node 10, 20 can be communicatively coupled (e.g. connected) to the memory 14 of the first network node 10, 20. In some embodiments, the memory 14 of the first network node 10, 20 may be for storing program code or instructions which, when executed by the processing circuitry 12 of the first network node 10, 20, cause the first network node 10, 20 to operate in the manner described herein in respect of the first network node 10, 20. For example, in some embodiments, the memory 14 of the first network node 10, 20 may be configured to store program code or instructions that can be executed by the processing circuitry 12 of the first network node 10, 20 to cause the first network node 10, 20 to operate in accordance with the method described herein in respect of the first network node 10, 20. Alternatively or in addition, the memory 14 of the first network node 10, 20 can be configured to store any information, data, messages, requests, responses, indications, notifications, signals, or similar, that are described herein. The processing circuitry 12 of the first network node 10, 20 may be configured to control the memory 14 of the first network node 10, 20 to store any of the information, data, messages, requests, responses, indications, notifications, signals, or similar, that are described herein.

In some embodiments, as illustrated in FIG. 8, the first network node 10, 20 may optionally comprise a communications interface 16. The communications interface 16 of the first network node 10, 20 can be communicatively coupled (e.g. connected) to the processing circuitry 12 of the first network node 10, 20 and/or the memory 14 of the first network node 10, 20. The communications interface 16 of the first network node 10, 20 may be operable to allow the processing circuitry 12 of the first network node 10, 20 to communicate with the memory 14 of the first network node 10, 20 and/or vice versa. Similarly, the communications interface 16 of the first network node 10, 20 may be operable to allow the processing circuitry 12 of the first network node 10, 20 to communicate with any one or more nodes (e.g. the second NRF node referred to herein, the first NF node 10 referred to herein in embodiments where the first network node is the first SCP node 20, and/or the first SCP node 20 referred to herein in embodiments where the first network node is the first NF node 10) and/or any other node. The communications interface 16 of the first network node 10, 20 can be configured to transmit and/or receive any of the information, data, messages, requests, responses, indications, notifications, signals, or similar, that are described herein. In some embodiments, the processing circuitry 12 of the first network node 10, 20 may be configured to control the communications interface 16 of the first network node 10, 20 to transmit and/or receive any of the information, data, messages, requests, responses, indications, notifications, signals, or similar, that are described herein.

Although the first network node 10, 20 is illustrated in FIG. 8 as comprising a single memory 14, it will be appreciated that the first network node 10, 20 may comprise at least one memory (i.e. a single memory or a plurality of memories) 14 that operate in the manner described herein. Similarly, although the first network node 10, 20 is illustrated in FIG. 8 as comprising a single communications interface 16, it will be appreciated that the first network node 10, 20 may comprise at least one communications interface (i.e. a single communications interface or a plurality of communications interfaces) 16 that operate in the manner described herein. It will also be appreciated that FIG. 8 only shows the components required to illustrate an embodiment of the first network node 10, 20 and, in practical implementations, the first network node 10, 20 may comprise additional or alternative components to those shown.

FIG. 9 illustrates a fifth method performed by the first network node 10, 20 in accordance with an embodiment. The fifth method is for managing information exchange between networks. The first network node 10, 20 described earlier with reference to FIG. 8 can be configured to operate in accordance with the fifth method of FIG. 9. The fifth method can be performed by or under the control of the processing circuitry 12 of the first network node 10, 20 according to some embodiments.

With reference to FIG. 9, as illustrated at block 110, information is acquired from a second NRF node 30. The first network node 10, 20 is a first NF node 10 or a first SCP node 20 that is configured to operate as an SCP between the first NF node 10 and the second NRF node 30. A visited network of the first NF node 10 comprises the second NRF node 30 and the first network node 10, 20. The information is indicative of whether a home network of the first NF node 10 is capable of performing a task delegated to the home network from the visited network.

In some embodiments, the information may be acquired in response to transmitting a third message towards the second NRF node 30. In some embodiments, the third message may comprise a first request that is a request for the information and/or a second request that is a request to discover one or more second NF nodes of the home network. In some embodiments, the third message may comprise an identifier that identifies the visited network.

In some embodiments, acquiring the information from the second NRF node 30 may comprise receiving a third message from the second NRF node 30, wherein the third message comprises the information. In some embodiments, the information may be acquired in a profile of a second NF node of the home network or a profile of a first SEPP node of the home network.

In some embodiments, the fifth method may comprise determining, based on the information, whether the home network is capable of performing the task.

In some embodiments, if the home network is incapable of performing the task, the fifth method may comprise performing the task or delegating the task to a second SEPP node of the visited network or a second SCP node of the visited network. The second SCP node can be configured to operate as an SCP between the first network node 10, 20 and the second SEPP node. In some embodiments, the second SCP node may be the closest SCP node of the visited network to the second SEPP node.

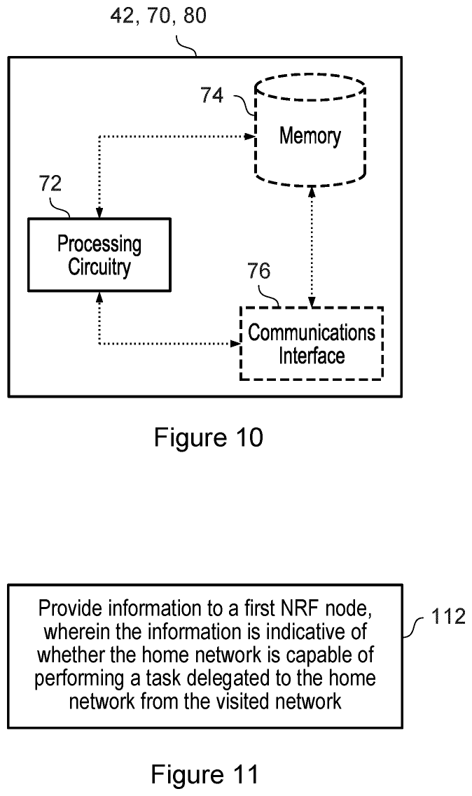

FIG. 10 illustrates a second network node 42, 70, 80 of a home network of a first NF node 10 in accordance with an embodiment. The second network node 42, 70, 80 is for managing information exchange between networks. In some embodiments, the second network node 42, 70, 80 referred to herein can refer to equipment capable, configured, arranged and/or operable to communicate directly or indirectly with the first NRF node 50 referred to herein, the second network node referred to herein, the second SCP node referred to herein, any second NF node referred to herein, and/or with other nodes or equipment to enable and/or to perform the functionality described herein. In some embodiments, the second network node 42, 70, 80 referred to herein can, for example, be a physical node (e.g. a physical machine or server) or a virtual node (e.g. a virtual machine, VM).

As illustrated in FIG. 10, the second network node 42, 70, 80 comprises processing circuitry (or logic) 72. The processing circuitry 72 controls the operation of the second network node 42, 70, 80 and can implement the method described herein in respect of the second network node 42, 70, 80. The processing circuitry 72 can be configured or programmed to control the second network node 42, 70, 80 in the manner described herein. The processing circuitry 72 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the second network node 42, 70, 80. In some embodiments, the processing circuitry 72 can be configured to run software to perform the method described herein in respect of the second network node 42, 70, 80. The software may be containerised according to some embodiments. Thus, in some embodiments, the processing circuitry 72 may be configured to run a container to perform the method described herein in respect of the second network node 42, 70, 80.

Briefly, the processing circuitry 72 of the second network node 42, 70, 80 is configured to provide information to a first NRF node 50. The second network node is a second NF node 70, 80 or a first SEPP node 42 and a home network of a first NF node 10 comprises the second network node 42, 70, 80 and the first NRF node 50. The information is indicative of whether the home network is capable of performing a task delegated to the home network from a visited network of the first NF node.

Alternatively or in addition, the processing circuitry 72 of the second network node 42, 70, 80 is configured to initiate transmission of a request towards a second network node of the home network in response to receiving the request. The request is received with a dummy address of a second NF node that signals that the request is to be transmitted towards the second network node without an address of the second NF node. The request is transmitted towards the second network node without the address.

As illustrated in FIG. 10, in some embodiments, the second network node 42, 70, 80 may optionally comprise a memory 74. The memory 74 of the second network node 42, 70, 80 can comprise a volatile memory or a non-volatile memory. In some embodiments, the memory 74 of the second network node 42, 70, 80 may comprise a non-transitory media. Examples of the memory 74 of the second network node 42, 70, 80 include, but are not limited to, a random access memory (RAM), a read only memory (ROM), a mass storage media such as a hard disk, a removable storage media such as a compact disk (CD) or a digital versatile disk (DVD), and/or any other memory.

The processing circuitry 72 of the second network node 42, 70, 80 can be communicatively coupled (e.g. connected) to the memory 74 of the second network node 42, 70, 80. In some embodiments, the memory 74 of the second network node 42, 70, 80 may be for storing program code or instructions which, when executed by the processing circuitry 72 of the second network node 42, 70, 80, cause the second network node 42, 70, 80 to operate in the manner described herein in respect of the second network node 42, 70, 80. For example, in some embodiments, the memory 74 of the second network node 42, 70, 80 may be configured to store program code or instructions that can be executed by the processing circuitry 72 of the second network node 42, 70, 80 to cause the second network node 42, 70, 80 to operate in accordance with the method described herein in respect of the second network node 42, 70, 80. Alternatively or in addition, the memory 74 of the second network node 42, 70, 80 can be configured to store any information, data, messages, requests, responses, indications, notifications, signals, or similar, that are described herein. The processing circuitry 72 of the second network node 42, 70, 80 may be configured to control the memory 74 of the second network node 42, 70, 80 to store any of the information, data, messages, requests, responses, indications, notifications, signals, or similar, that are described herein.

In some embodiments, as illustrated in FIG. 10, the second network node 42, 70, 80 may optionally comprise a communications interface 76. The communications interface 76 of the second network node 42, 70, 80 can be communicatively coupled (e.g. connected) to the processing circuitry 72 of the second network node 42, 70, 80 and/or the memory 74 of the second network node 42, 70, 80. The communications interface 76 of the second network node 42, 70, 80 may be operable to allow the processing circuitry 72 of the second network node 42, 70, 80 to communicate with the memory 74 of the second network node 42, 70, 80 and/or vice versa. Similarly, the communications interface 76 of the second network node 42, 70, 80 may be operable to allow the processing circuitry 72 of the second network node 42, 70, 80 to communicate with any one or more nodes (e.g. the first NRF node 50 referred to herein) and/or any other node. The communications interface 76 of the second network node 42, 70, 80 can be configured to transmit and/or receive any of the information, data, messages, requests, responses, indications, notifications, signals, or similar, that are described herein. In some embodiments, the processing circuitry 72 of the second network node 42, 70, 80 may be configured to control the communications interface 76 of the second network node 42, 70, 80 to transmit and/or receive any of the information, data, messages, requests, responses, indications, notifications, signals, or similar, that are described herein.

Although the second network node 42, 70, 80 is illustrated in FIG. 10 as comprising a single memory 74, it will be appreciated that the second network node 42, 70, 80 may comprise at least one memory (i.e. a single memory or a plurality of memories) 74 that operate in the manner described herein. Similarly, although the second network node 42, 70, 80 is illustrated in FIG. 10 as comprising a single communications interface 76, it will be appreciated that the second network node 42, 70, 80 may comprise at least one communications interface (i.e. a single communications interface or a plurality of communications interfaces) 76 that operate in the manner described herein. It will also be appreciated that FIG. 10 only shows the components required to illustrate an embodiment of the second network node 42, 70, 80 and, in practical implementations, the second network node 42, 70, 80 may comprise additional or alternative components to those shown.

FIG. 11 illustrates a sixth method performed by a second network node 42, 70, 80 of a home network of a first NF node 10 in accordance with an embodiment. The sixth method is for managing information exchange between networks. The second network node 42, 70, 80 described earlier with reference to FIG. 10 can be configured to operate in accordance with the sixth method of FIG. 11. The sixth method can be performed by or under the control of the processing circuitry 72 of the second network node 42, 70, 80 according to some embodiments.

With reference to FIG. 11, as illustrated at block 112, information is provided to a first NRF node 50. The second network node is a second NF node 70, 80 or a first SEPP node 42 and a home network of a first NF node 10 comprises the second network node 42, 70, 80 and the first NRF node 50. The information is indicative of whether the home network is capable of performing a task delegated to the home network from a visited network of the first NF node.

In some embodiments, providing the information to the first NRF node 50 may comprise initiating transmission of the information towards the first NRF node 50. In some embodiments, the information may be provided in a profile of the second network node 42, 70, 80. In some embodiments, the information may be provided with a request to register the profile at the first NRF node 50.

In some embodiments, the first NF node 10 referred to herein may be an NF node 10 of a consumer. In other embodiments, the first NF node 10 referred to herein may be an NF node of a producer. In some embodiments, the task referred to herein may be to select one or more second NF nodes 70, 80 of the home network. In some embodiments, the first NF node 10 referred to herein may be an NF node of a consumer and the task referred to herein may be to select one or more second NF nodes 70, 80 of a producer to provide a service requested by the first NF node 10. In other embodiments, the first NF node 10 referred to herein may be an NF node of a producer and the task referred to herein may be to select one or more second NF nodes 70, 80 of a consumer to provide a notification requested by the first NF node 10.

In the manner described herein, the first NF node 10 and/or the first SCP node 20 can be informed of the home network capabilities to perform a task (e.g. a (re)selection of second NF nodes) in data returned by the first NRF node 50. There is a mechanism described to inform the visited network, from the home network, about whether the home network supports delegation of a task (e.g. a (re)selection of second NF nodes), such as in case of indirect communication. New data may provide the visited network capabilities. In some embodiments, this new data can be inserted (by different means) in the data returned by the first NRF node 50.

Some embodiments will now be described with reference to different variants for providing the capability information referred to herein:
Variant 1) Information Provided in Nrf Discovery Response (at Registration):
   It is possible to use data that makes sense to be returned in a discovery result, i.e. included as new data in one or more NF profiles (Variant 1-A) or in an SEPP profile (Variant 1-B). In such an embodiment, the second NF node(s) or first SEPP node 42 of the home network registers the new data (at NRF registration). In existing techniques, the visited network does not discover the profile of the first SEPP node 42 of the home network, since the discovery is routed from the first NRF node of the home network to second NRF node of the visited network via the SEPP node (i.e. the second SEPP node 44 of the visited network and the first SEPP node 42 of the home network) already. As such, the SEPP profile is expected to be used intra-network (e.g. intra-PLMN) only. The embodiment according to Variant 1 requires new SEPP information to be registered in the first NRF node 50 of the home network.
Variant 2) Information provided in NRF discovery response (inserted by NRF):
   As an alternative, to avoid impacting the NF registration, the new data can be inserted by the first NRF node 50 itself (e.g. based on configuration). The new data can be inserted in the NF profile of one or more second NF nodes (Variant 2-A), or the new data can be inserted in an SEPP profile (Variant 2-B).
Variant 3) Information provided in NRF discovery response (inserted by SEPP):
   As another alternative, the new data can be inserted by the SEPP node itself (e.g. based on configuration) in the discovery response. The new data can be inserted in the NF profile of one or more second NF nodes (Variant 3-A) or the new data can be inserted in an SEPP profile (Variant 3-B).
Variant 4) Information Provided in New Nrf Service:
   As another alternative, a new service can be provided by the first NRF node 50 to specifically provide the home network capabilities. In this way, information does not need to be conveyed as part of the existing profiles (returned in the discovery response). Instead, the new data can be included in a new service response. Specifically, a new data structure may be defined, e.g. PLMN data.

In the manner described herein, the visited network advantageously knows whether the home network is able to process a request with delegation of a task (e.g. (re)selection of second NF nodes). According to some embodiments, based on this knowledge, the visited network may only perform delegation of the logic that the home network will be able to (e.g. properly) execute.

If the home network is unable to perform the task (e.g. the home network is Model B or Model C(target)), then the home network may perform one of the following three options:
a) not delegate the task (and optionally instead follow state of the art behaviour);
b) delegate the task to the visited network (e.g. the second SEPP node 44 of the visited network can take the role of an SCP, being able to perform the task); or
c) delegate the task to a specific SCP of the visited network that may be defined as a kind of “border” SCP, i.e. it acts as the last SCP before the second SEPP node 44 of the visited network. The intention is that this “border SCP” is placed as close as possible to the second SEPP node 44 of the visited network, in order to minimise signalling paths (e.g. if reselection is required).

There is also provided a system comprising any two or more of the first NRF node 50 described herein, the second NRF node 30 described herein, the first network node 10, 20 described herein, and the second network node 42, 70, 80 described herein. A method performed by the system comprises the method described herein in respect of any two or more of the first NRF node 50, the second NRF node 30, the first network node 10, 20, and the second network node 42, 70, 80.

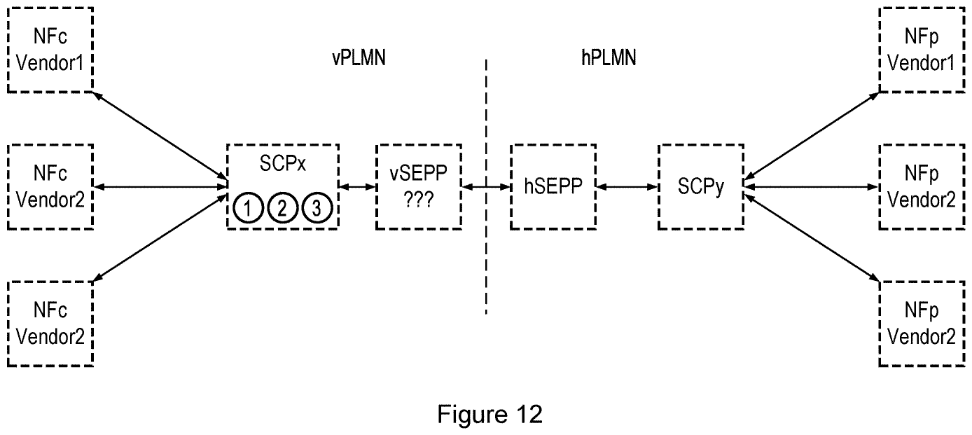

FIG. 12 illustrates a system according to an embodiment. The system comprises a visited network (vPLMN) of a first NF node and a home network (hPLMN) of the first NF node. The first NF node can, for example, be an NF node of a consumer (NFc). In the embodiment illustrated in FIG. 12, the visited network comprises at least one first NF node (NFc), a first SCP node (SCPx), and a first SEPP node (vSEPP), and the home network comprises at least one second NF node (NFp), a second SCP node (SCPy), and a second SEPP node (hSEPP). The at least one second NF node can, for example, be at least one NF node of a producer (NFp).

Currently, the 3GPP definition of indirect communication is assumed to be only intra-PLMN, since nothing is said specifically regarding delegation when roaming from a vPLMN to a hPLMN. That is, the delegation of NFp (re)selection logic is not currently standardized. This can be summarized with reference to FIG. 12.

It is currently the case that, within a PLMN (vPLMN in the example illustrated in FIG. 12), it is possible to delegate (from NFc to SCP) some (re)selection logic with the help of different pieces of information transferred from NFc to SCP. In the example illustrated in FIG. 12, the circles 1, 2, 3 represent the different pieces of information. The first circle 1 represents information about a selection of service producer instance candidates. The second circle 2 represents information about an initial selection of one service producer instance. The third circle 3 represents information about a reselection of an alternative service producer instance. Three different alternatives of delegation of the (re)selection of an NF instance to PLMN are possible. The first alternative is that there is no delegation of (re)selection. The second alternative is that there is delegation of non-functional (re)selection (the information represented by circles 2 and 3). The third alternative is that there is delegation of functional and non-functional (re)selection (the information represented by circles 1, 2 and 3).

If the information represented by circles 1, 2 and 3 is delegated to SCPx, it is not currently described whether this delegation can go even further across PLMNs. In fact, one SCP in the vPLMN is expected to provide the target destination (3gpp-Sbi-Target-apiRoot). This means that SCPx (or another SCP in the vPLMN if one exists) is to perform initial selection, and this one SCP is also be expected to perform reselection (e.g. in case of failure). Although different alternatives of delegation of logic are described with reference to FIG. 12, it is currently the case that only the first alternative is considered for inter-PLMN communication, since nothing else is considered in 3GPP.

However, delegating (re)selection logic has some advantages and it may be requested by some customers in the near future. An issue exists in that Stage 2 does not consider any requirements for indirect communication in Model C across PLMNs. If initial selection logic is delegated to the hPLMN, then this means that hPLMN will select the NF target (NFp). If the NF target (NFp) is previously selected in the vPLMN, then this selection is useless. Different cases are possible depending on the indirect communication models deployed in vPLMN.

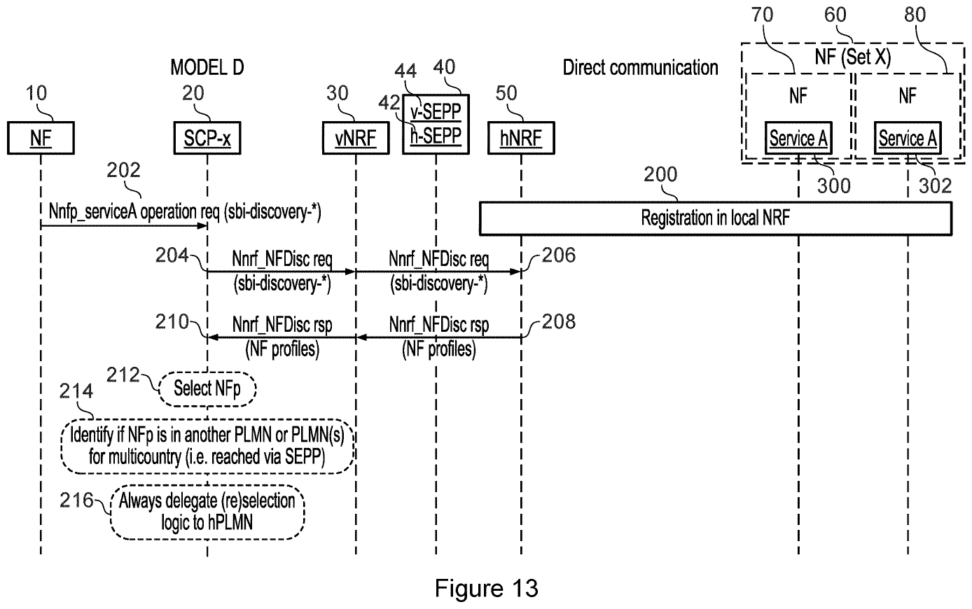

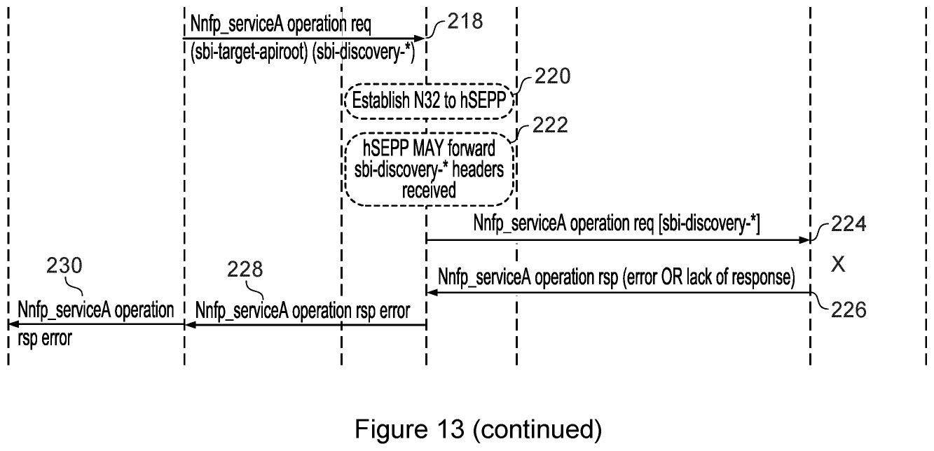

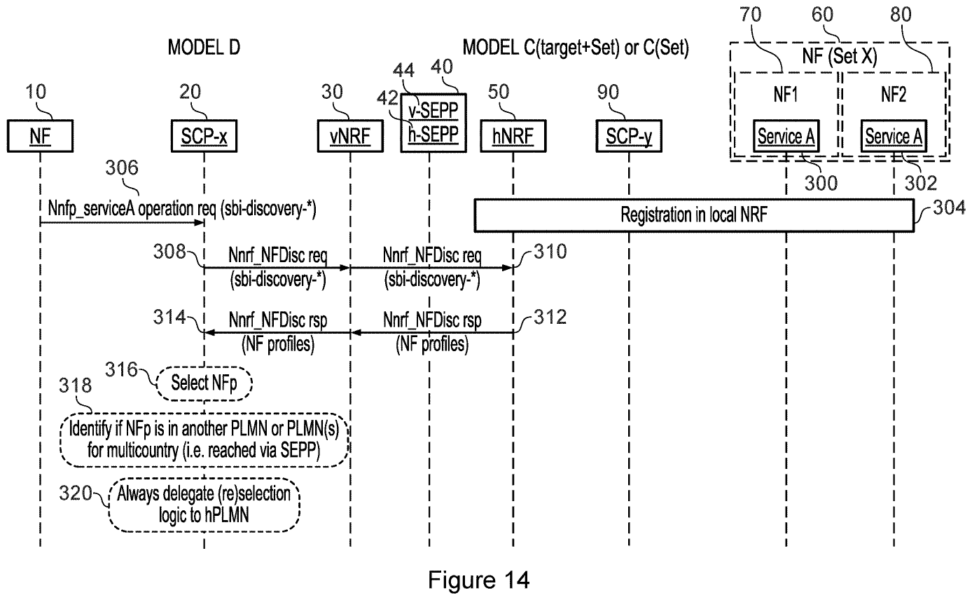

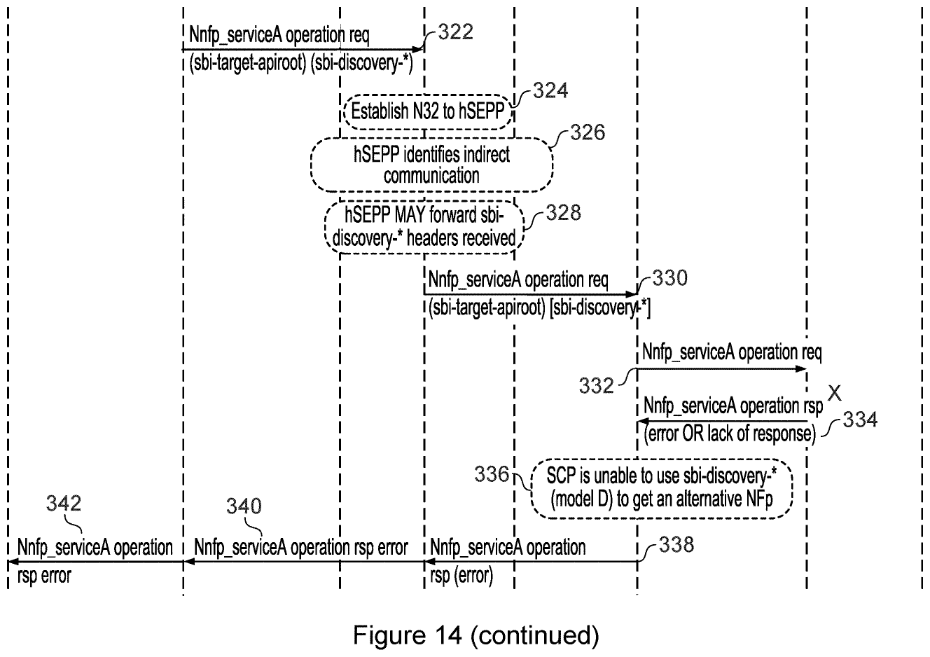

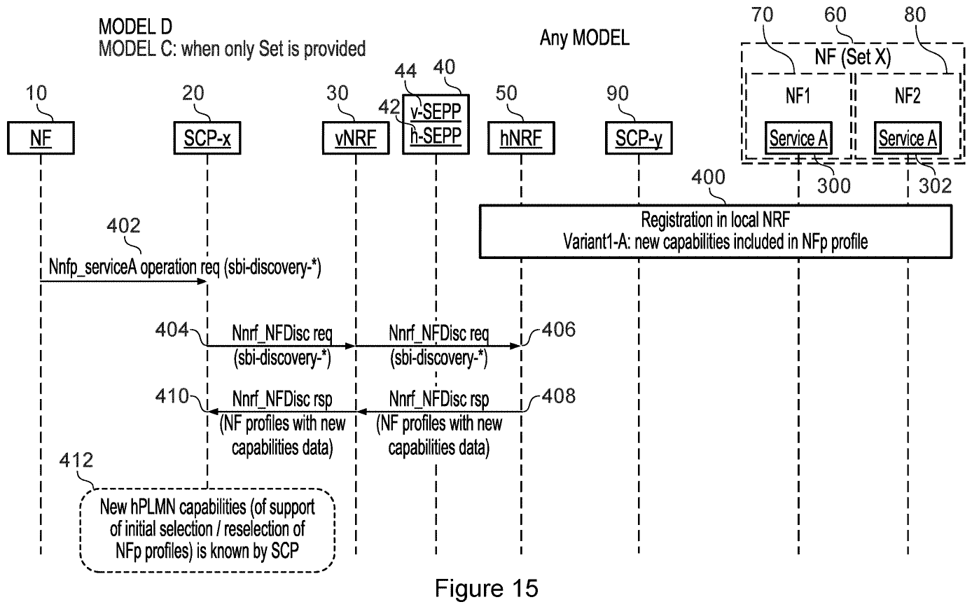

Some example systems will now be described with reference to the signalling diagrams of FIGS. 13 to 24. As will become apparent from the description with reference to FIGS. 13 and 14, there exists an issue with existing techniques and, as will become apparent from the description with reference to FIGS. 15 to 24, this issue can be addressed using the technique described herein.

FIG. 13 is a signalling diagram illustrating an exchange of signals in an example system. It illustrates an issue with existing techniques whereby there is an incompatibility between networks.

The system illustrated in FIG. 13 comprises a first NF node 10, a first SCP node 20 of a visited network (e.g. a visited PLMN) of the first NF node, a second NRF node 30 of the visited network, an SEPP node 40, a first NRF node 50 of a home network (e.g. a home PLMN) of the first NF node 10, and a plurality of second NF nodes 70, 80 in the home network. The SEPP node 40 comprises a first SEPP node 42 of the home network and a second SEPP node 44 of the visited network. The first SCP node 20 is configured to operate as an SCP between the first NF node 10 and the second NRF node 30 (and as an SCP between the first NF node 10 and the second SEPP node 44).

In the example illustrated in FIG. 13, the plurality of second NF nodes 70, 80 comprise two second NF nodes. However, it will be understood that the system illustrated in FIG. 13 can comprise one or more (i.e. any number of) second NF nodes. In the example illustrated in FIG. 13, a set of second NF nodes (“NF (Set X)”) comprises the plurality of second NF nodes 70, 80.

The exchange of signals between the nodes of the system illustrated in FIG. 13 will be described in terms of a service request. The plurality of second NF nodes 70, 80 can thus each be configured to provide a service 300, 302. Also, the first NF node 10 can be an NF node of a (service) consumer (NFc) and the plurality of second NF nodes can be a plurality of NF nodes of a (service) producer (NFps). However, it will be understood that other requests are also possible. For example, the service request of FIG. 13 may be replaced with a notification request. In some such examples, the first NF node 10 can be an NF node of a (service) producer (NFp) and the plurality of second NF nodes can be a plurality of NF nodes of a (service) consumer (NFcs).

As illustrated by block 200 of FIG. 13, the plurality of second NF nodes 70, 80 are registered in the first NRF node 50. For example, NF profiles of the plurality of second NF nodes 70, 80 may be stored in (e.g. a memory of) the first NRF node 50. An NF profile of a second NF node can comprise one or more of information indicative of the identity of a second NF node, information indicative of the set in which the second NF node is comprised, and information indicative of one or more services that the second NF node is configured to provide.

As illustrated by arrow 202 of FIG. 13, the first NF node 10 transmits a service request towards the first SCP node 20. The first SCP node 20 thus receives the service request from the first NF node 10. The service request is for a service requested by the first NF node 10. The first NF node 10 may transmit a request that is adapted to indirect communication in Model D (e.g. including parameters to allow the first SCP node 20 to perform initial selection and reselection).

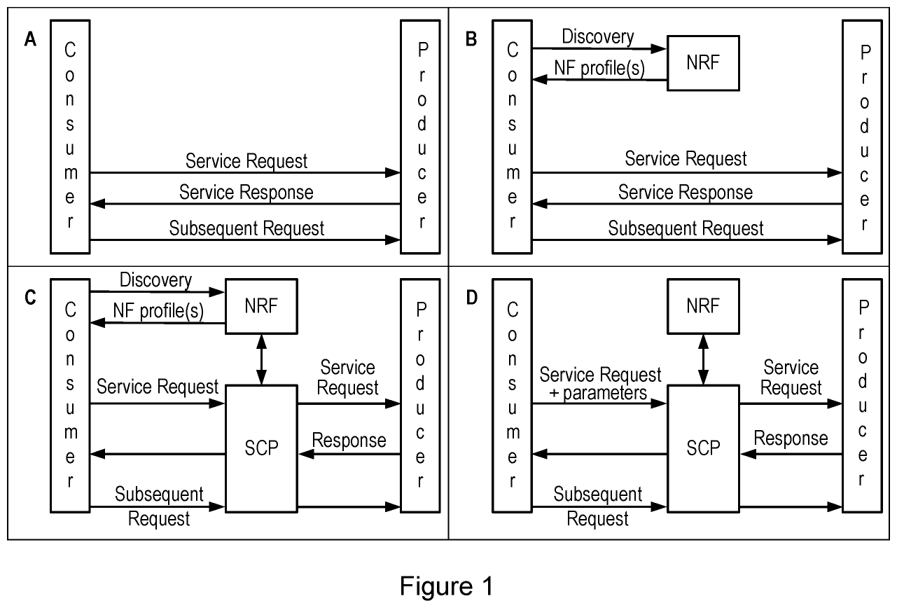

According to an indirect communication model with delegated discovery (e.g. as described earlier with reference to FIG. 1D), the first NF node 10 sends one or more discovery parameters (or factors) required to find one or more suitable second NF nodes and the first SCP node 20 can discover one or more second NF nodes via the second NRF node 30 by using the received one or more discovery parameters. Thus, in the embodiment illustrated in FIG. 13, the service request can comprise one or more discovery parameters (“sbi-discovery-* ”) on the basis of which the first SCP node 20 is to discover one or more second NF nodes. The discovery parameters can contain information for initial functional selection.

As illustrated by arrows 204 to 210 of FIG. 13, an NF selection is performed in the visited network. In more detail, as illustrated by arrow 204 of FIG. 13, the first SCP node 20 transmits a discovery request towards the second NRF node 30. The second NRF node 30 thus receives the discovery request from the first SCP node 20. As illustrated by arrow 206 of FIG. 13, the second NRF node 30 transmits the discovery request towards the first NRF node 50 via the SEPP node 40 (i.e. via the second SEPP node 44 and the first SEPP node 42). The first NRF node 50 thus receives the discovery request from the first SCP node 20. The discovery request is a request for information indicative of one or more second NF nodes for providing the service. The discovery request can comprise the one or more discovery parameters (e.g. “sbi-discovery-* ”).

As illustrated by arrow 208 of FIG. 13, the first NRF node 50 transmits a discovery response towards the second NRF node 30 via the SEPP node 40 (i.e. via the first SEPP node 42 and the second SEPP node 44). The second NRF node 30 thus receives the discovery response from the first NRF node 50. As illustrated by arrow 210 of FIG. 13, the second NRF node 30 transmits the discovery response towards the first SCP node 20. The first SCP node 20 thus receives the discovery response from the second NRF node 30. The discovery response comprises information indicative of the plurality of second NF nodes 70, 80 for providing the service. The discovery response can, for example, comprise profiles of the plurality of second NF nodes 70, 80. Thus, steps 204 to 210 can involve the discovery of NF profiles. This requires inter-network (e.g. PLMN) communication to acquire the profiles registered in the home network (e.g. home PLMN).

As illustrated by block 212 of FIG. 13, there is a selection of one or more second NF nodes among the results. More specifically, the first SCP node 20 selects one or more second NF nodes of the plurality of second NF nodes 70, 80 to which to transmit the service request received from the first NF node 10. The selection can be based on any existing technique and a person skilled in the art will be aware of various techniques in this regard, such as any of those mentioned earlier. Thus, it is an SCP node in the home network that performs the initial selection. In the example illustrated in FIG. 13, the first SCP node 20 selects the second NF node 70. As an alternative to the first SCP node 20 performing NRF discovery (as illustrated by arrows 204-210 of FIG. 13), the first SCP node 20 may select a second NF node based on cached results.

As illustrated by block 214 of FIG. 13, the first SCP node 20 identifies whether the selected second NF node 70 is in another network. That is, the first SCP node 20 identifies whether the selected second NF node 70 is reached via the SEPP node 40. In the embodiment illustrated in FIG. 13, the first SCP node 20 identifies that the selected second NF node 70 is reached via the SEPP node 40. The selected second NF node 70 is in the home network of the first NF node 10, whereas the first SCP node 20 is in the visited network of the first NF node 10.

As illustrated by block 216 of FIG. 13, the first SCP node 20 delegates (re)selection logic to the home network. For example, once it is known that the service request needs to reach another network (via the SEPP node 40), then the visited network (or, more specifically, the second SEPP node 44) may decide to delegated (re)selection to the home network. The visited network (or, more specifically, the second SEPP node 44) may therefore provide the information required for (re)selection of a second NF node to the home network. That is, it provides the discovery parameters (e.g. sbi-discovery-*).

As illustrated by arrow 218 of FIG. 13, the first SCP node 20 transmits the service request towards the SEPP node 40 (or, more specifically, the second SEPP node 44 of the visited network). The second SEPP node 44 receives the service request from the first SCP node 20. The request is sent to the SEPP node 40 (or, more specifically, the second SEPP node 44) to reach the corresponding home network of the first NF node 10. In the service request, according to the current 3GPP standard, the selected target second NF node 70 is included in the target destination (3gpp-Sbi-Target-apiRoot) header. The target destination referred to herein can be the application programming interface (API) root of a uniform resource identifier (URI) for the selected second NF node 70. The API root of the URI can also be referred to as a “3gpp-Sbi-Target-apiRoot”.

The target destination is used in step 218 of FIG. 13 towards the second SEPP node 44. For example, the target destination is included in the service request to the second SEPP node 44. In order to allow delegation of initial selection, the parameters used to discover the possible destination second NF nodes are provided. For example, sbi-discovery-* is provided. The discovery parameters (e.g. sbi-discovery-*) are included in the service request transmitted towards the SEPP node 40 in order to provide information to the home network.

As illustrated by block 220 of FIG. 13, the second SEPP node 44 of the visited network establishes an interface (namely, an N32 interface) to the first SEPP node 42 of the home network. That is, an interface is established between the second SEPP node 44 and the first SEPP node 42. As illustrated by block 222 of FIG. 13, the first SEPP node 42 may decide to forward the discovery parameters (e.g. sbi-discovery-*) headers received. For example, the first SEPP node 42 may forward all received headers or, if it is not specified, the sbi-discovery-* header used for indirect communication may be removed by the first SEPP node 42 according to some implementations.

As illustrated by arrow 224 of FIG. 13, the first SEPP node 42 transmits the service request towards the selected second NF node 70. The selected second NF node 70 thus receives the service request from the first SEPP node 42. The service request transmitted towards the selected second NF node 70 may include the discovery parameters (e.g. sbi-discovery-*) , but this information is irrelevant for the second NF node 70.

As illustrated by the cross “X” in FIG. 13, there may be an error that means that the service request cannot be executed. If an error is produced, the home network does not have any means by which it can find an alternative second NF node. Therefore, it is not possible for (re)selection to be performed in the home network, but the visited network has delegated this task.

As illustrated by arrow 226 of FIG. 13, the selected second NF node 70 transmits a response to the service request towards the SEPP node 40 and the SEPP node 40 (or, more specifically, the first SEPP node 42) may thus receive the response from the selected second NF node 70. The response can indicate that the service request is unsuccessful, e.g. that the selected second NF node 70 has failed to successfully execute the service request, or that there has been an error. Alternatively, the error may result in no response or a lack of response. As illustrated by arrow 228 of FIG. 13, in the case that the SEPP node 40 receives a response, the SEPP node 40 (or, more specifically, the second SEPP node 44) may transmit the response to the first SCP node 20 and the first SCP node 20 may thus receive the response from the SEPP node 40. As illustrated by arrow 230 of FIG. 13, the first SCP node 20 may transmit the response to the first NF node 10 and the first NF node 10 may thus receive the response from the first SCP node 20. The error is thus propagated to the visited network by way of steps 226 to 230 of FIG. 13.

Therefore, as illustrated in FIG. 13, the delegation of (re)selection is not achieved and an error occurs.

FIG. 14 is a signalling diagram illustrating an exchange of signals in another example system. It illustrates an issue with existing techniques whereby there is an incompatibility between networks.

The system illustrated in FIG. 14 comprises a first NF node 10, a first SCP node 20 of a visited network (e.g. a visited PLMN) of the first NF node, a second NRF node 30 of the visited network, an SEPP node 40, a first NRF node 50 of a home network (e.g. a home PLMN) of the first NF node 10, a second SCP node 90 of the home network, and a plurality of second NF nodes 70, 80 in the home network. The SEPP node 40 comprises a first SEPP node 42 of the home network and a second SEPP node 44 of the visited network. The first SCP node 20 is configured to operate as an SCP between the first NF node 10 and the second NRF node 30 (and as an SCP between the first NF node 10 and the second SEPP node 44). The second SCP node 90 is configured to operate as an SCP between the first NRF node 50 and the plurality of second NF nodes 70, 80 (and as an SCP between the first SEPP node 42 and the plurality of second NF nodes 70, 80).

In the example illustrated in FIG. 14, the plurality of second NF nodes 70, 80 comprise two second NF nodes. However, it will be understood that the system illustrated in FIG. 14 can comprise one or more (i.e. any number of) second NF nodes. In the example illustrated in FIG. 14, a set of second NF nodes (“NF (Set X)”) comprises the plurality of second NF nodes 70, 80.

The exchange of signals between the nodes of the system illustrated in FIG. 14 will be described in terms of a service request. The plurality of second NF nodes 70, 80 can thus each be configured to provide a service 300, 302. Also, the first NF node 10 can be an NF node of a (service) consumer (NFc) and the plurality of second NF nodes can be a plurality of NF nodes of a (service) producer (NFps). However, it will be understood that other requests are also possible. For example, the service request of FIG. 14 may be replaced with a notification request. In some such examples, the first NF node 10 can be an NF node of a (service) producer (NFp) and the plurality of second NF nodes can be a plurality of NF nodes of a (service) consumer (NFcs).

Steps 304 to 324 of FIG. 14 are as described earlier with reference to steps 200 to 220 of FIG. 13 respectively.

As illustrated by block 326 of FIG. 14, the SEPP node 40 (or, more specifically, the first SEPP node 42) identifies that the home network has a configured second SCP node 90 for the traffic. That is, the SEPP node 40 (or, more specifically, the first SEPP node 42) can identify that indirect communication is at least deployed for inbound roamer traffic (e.g. traffic from the first NF node 10). As such, in some embodiments, the first SEPP node 42 may identify that the service request received at step 322 of FIG. 14 is to be sent to the second SCP node 90 instead of the selected second NF node 70 in the home network.

Step 328 of FIG. 14 is as described earlier with reference to step 222 of FIG. 13.

As illustrated by arrow 330 of FIG. 14, the first SEPP node 42 transmits the service request towards the second SCP node 90 instead of towards the selected second NF node 70. The selected second SCP node 90 thus receives the service request from the first SEPP node 42. The service request transmitted towards the second SCP node 90 may include the target destination (e.g. 3gpp-Sbi-Target-apiRoot) and/or the discovery parameters (e.g. sbi-discovery-*) . The target destination is the selected second NF node 70.

As illustrated by arrow 332 of FIG. 14, the second SCP node 90 transmits the service request towards the selected second NF node 70. The selected second NF node 70 thus receives the service request from the second SCP node 90. As illustrated by the cross “X” in FIG. 14, there may be an error that means that the service request cannot be executed.

As illustrated by arrow 334 of FIG. 14, the selected second NF node 70 transmits a response to the service request towards the second SCP node 90. The second SCP node 90 thus receives the response. The response can indicate that the service request is unsuccessful, e.g. that the selected second NF node 70 has failed to successfully execute the service request, or that there has been an error. Alternatively, the error may result in no response or a lack of response.

As illustrated by block 336 of FIG. 14, if an error is produced and the second SCP node 90 only supports Model C, the second SCP node 90 is unable to use the discovery parameters (Model D, with functional information, e.g. sbi-discovery-*) to find an alternative second NF node in the home network, even if the second SCP node 90 received the discovery parameters from first SEPP node 42 at step 330 of FIG. 14. The home network does not have any means by which it can find an alternative second NF node. Therefore, it is not possible for (re)selection to be performed in the home network, but the visited network has delegated this task.

As illustrated by arrow 338 of FIG. 14, the second SCP node 90 may transmit the response to the SEPP node 40 and the SEPP node 40 (or, more specifically, the first SEPP node 42) may thus receive the response from the selected second NF node 70. Steps 340 and 342 of FIG. 14 are as described earlier with reference to steps 228 and 230 of FIG. 13 respectively.

Therefore, as illustrated in FIG. 14, the delegation of (re)selection is not achieved and an error occurs.

The problems described with reference to FIGS. 13 and 14 can be resolved by way of the techniques described herein, such as in the manner illustrated in FIGS. 15 to 24. FIGS. 15 to 24 consider the different cases described above that support indirect communication in the visited network.

FIG. 15 is a signalling diagram illustrating an exchange of signals in a system according to an embodiment. This embodiment is an example of Variant 1 or, more specifically, Variant 1-A.

The system illustrated in FIG. 15 comprises a first SCP node 20 of a visited network (e.g. a visited PLMN) of a first NF node 10, a second NRF node 30 of the visited network, an SEPP node 40, a first NRF node 50 of a home network (e.g. a home PLMN) of the first NF node 10, and a plurality of second NF nodes 70, 80 of the home network. The SEPP node 40 comprises a first SEPP node 42 of the home network and a second SEPP node 44 of the visited network. The first SCP node 20 is configured to operate as an SCP between the first NF node 10 and the second NRF node 30 (and as an SCP between the first NF node 10 and the second SEPP node 44). The first SCP node 20, the second NRF node 30, the first SEPP node 42, the first NRF node 50, and the plurality of second NF nodes 70, 80 can be as described earlier with reference to FIGS. 2 to 11.

The system illustrated in FIG. 15 can also comprise the first NF node 10 and a second SCP node 90 of the home network. The second SCP node 90 can be configured to operate as an SCP between the first NRF node 50 and the plurality of second NF nodes 70, 80 (and as an SCP between the first SEPP node 42 and the plurality of second NF nodes 70, 80).

In the example illustrated in FIG. 15, the plurality of second NF nodes 70, 80 comprise two second NF nodes (i.e. “NF1” and “NF2”). However, it will be understood that the system illustrated in FIG. 15 can comprise one or more (i.e. any number of) second NF nodes. In the example illustrated in FIG. 15, a set of second NF nodes (“NF (Set X)”) comprises the plurality of second NF nodes 70, 80.

The exchange of signals between the nodes of the system illustrated in FIG. 15 will be described in terms of a service request. The plurality of second NF nodes 70, 80 can thus each be configured to provide a service 300, 302. Also, the first NF node 10 can be an NF node of a (service) consumer (NFc) and the plurality of second NF nodes can be a plurality of NF nodes of a (service) producer (NFps). However, it will be understood that other requests are also possible. For example, the service request of FIG. 15 may be replaced with a notification request. In some such examples, the first NF node 10 can be an NF node of a (service) producer (NFp) and the plurality of second NF nodes can be a plurality of NF nodes of a (service) consumer (NFcs).

As illustrated by block 400 of FIG. 15, the second NF nodes 70, 80 provide information to the first NRF node 50 and thus the first NRF node 50 acquires the information. The information is indicative of whether the home network is capable of performing a task delegated to the home network from the visited network. Thus, the information may also be referred to herein as capability information.

In some embodiments, the capability information may be provided to the first NRF node 50 by registering NF (e.g. NFp) and SEPP profiles in the first NRF node 50. In these embodiments, the capability information can be included in the profile of one or more second NF nodes 70, 80 and/or the first SEPP node 42. For example, information about the support of the home network of (re)selection of NF capabilities may be included in such profiles.

Steps 402 to 406 of FIG. 15 are as described earlier with reference to steps 202 to 206 of FIG. 13 respectively.

In the embodiment illustrated in FIG. 15, at step 402, the first NF node 10 is configured to use indirect communication with Model D. As such, discovery parameters (e.g. sbi-discovery-*) can comprise information for an initial functional selection. If the first NF node 10 is instead configured to use indirect communication with Model C (with the variant where the first NF node 10 only provides the Set), then the discovery parameters (e.g. sbi-discovery-*) can comprise the NF Set. The NF Set is a set of second NF nodes from which one or more second NF nodes are to be selected.

In the embodiment illustrated in FIG. 15, at steps 404 and 406, the first SCP node 20 is to perform an initial selection of one or more second NF nodes. As such, the first SCP node 20 may acquire the corresponding NF profile(s). Since the first NF node 10 is in another network (which may be known based on information provided in the service request received at step 402), then the second NRF node 30 acquires those NF profile(s) from the corresponding home network. As such, the NRF discovery request is sent via the SEPP node 40 towards the corresponding first NFR node 50.

As illustrated by arrow 408 of FIG. 15, the first NRF node 50 provides the capability information to the second NRF node 30 and the second NRF node 30 thus acquires the capability information. More specifically, the first NRF node 50 transmits the capability information to the second NRF node 30 and the second NRF node 30 thus receives the capability information.

As illustrated by arrow 410 of FIG. 15, the second NRF node 30 provides the capability information to the first SCP node 20 and the first SCP node 20 thus acquires the capability information. More specifically, the second NRF node 30 transmits the capability information to the first SCP node 20 and the first SCP node 20 thus receives the capability information.

At steps 408 and 410 of FIG. 15, the capability information can be transmitted in the discovery response. The discovery response can also comprise the acquired NF profile(s). For example, in some embodiments, the discovery results can comprise NF profile(s) and those NF profile(s) may comprise the capability information.

Therefore, as illustrated in FIG. 15, new capabilities can be included in a profile at registration according to some embodiments. As illustrated by block 412 of FIG. 15, the capabilities of the home network are advantageously known by the first SCP node 20.

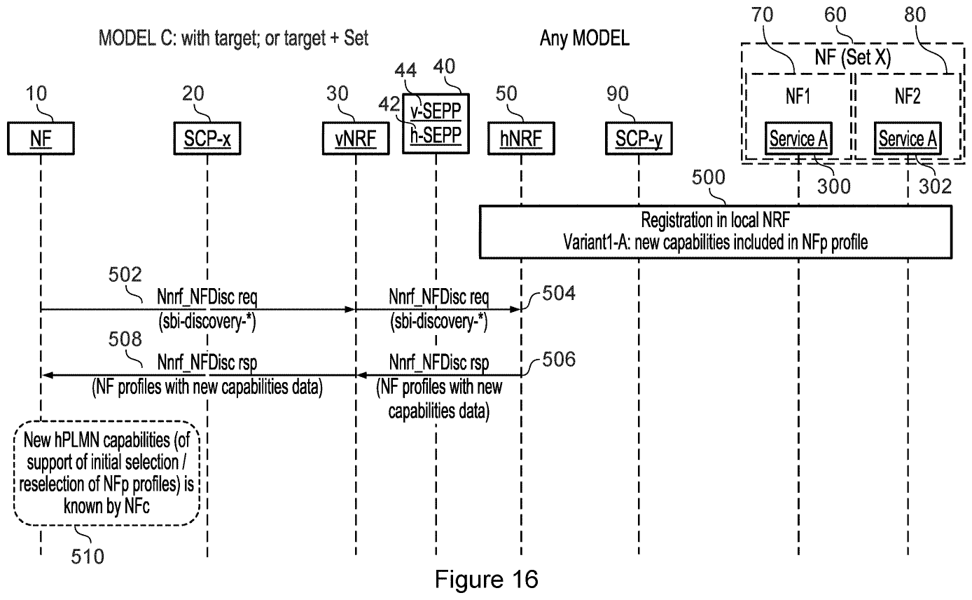

FIG. 16 is a signalling diagram illustrating an exchange of signals in a system according to an embodiment. This embodiment is an example of Variant 1 or, more specifically, Variant 1-A.

The system illustrated in FIG. 16 comprises a first SCP node 20 of a visited network (e.g. a visited PLMN) of a first NF node 10, a second NRF node 30 of the visited network, an SEPP node 40, a first NRF node 50 of a home network (e.g. a home PLMN) of the first NF node 10, and a plurality of second NF nodes 70, 80 of the home network. The SEPP node 40 comprises a first SEPP node 42 of the home network and a second SEPP node 44 of the visited network. The first SCP node 20 is configured to operate as an SCP between the first NF node 10 and the second NRF node 30 (and as an SCP between the first NF node 10 and the second SEPP node 44). The first SCP node 20, the second NRF node 30, the first SEPP node 42, the first NRF node 50, and the plurality of second NF nodes 70, 80 can be as described earlier with reference to FIGS. 2 to 11.

The system illustrated in FIG. 16 can also comprise the first NF node 10 and a second SCP node 90 of the home network. The second SCP node 90 can be configured to operate as an SCP between the first NRF node 50 and the plurality of second NF nodes 70, 80 (and as an SCP between the first SEPP node 42 and the plurality of second NF nodes 70, 80).

In the example illustrated in FIG. 16, the plurality of second NF nodes 70, 80 comprise two second NF nodes (i.e. “NF1” and “NF2”). However, it will be understood that the system illustrated in FIG. 16 can comprise one or more (i.e. any number of) second NF nodes. In the example illustrated in FIG. 16, a set of second NF nodes (“NF (Set X)”) comprises the plurality of second NF nodes 70, 80.

The exchange of signals between the nodes of the system illustrated in FIG. 16 will be described in terms of a service request. The plurality of second NF nodes 70, 80 can thus each be configured to provide a service 300, 302. Also, the first NF node 10 can be an NF node of a (service) consumer (NFc) and the plurality of second NF nodes can be a plurality of NF nodes of a (service) producer (NFps). However, it will be understood that other requests are also possible. For example, the service request of FIG. 16 may be replaced with a notification request. In some such examples, the first NF node 10 can be an NF node of a (service) producer (NFp) and the plurality of second NF nodes can be a plurality of NF nodes of a (service) consumer (NFcs).

FIG. 16 is similar to FIG. 15, except that FIG. 16 corresponds to an embodiment where indirect communication in the visited network follows Model C with target or Model C with target+Set. Model C with target is where the first NF node 10 includes a target destination (e.g. 3gpp-Sbi-Target-apiRoot) in a request, whereas Model C with target+Set is where the first NF node 10 includes a target destination (e.g. 3gpp-Sbi-Target-apiRoot) and an NF Set in a request. This request will be sent after step 510 of FIG. 16, from the first NF node 10 to the first SCP node 20. Prior to that, the first NF node 10 needs to know whether a task (e.g. (re)selection) may be delegated to the home network. That is, the first NF node 10 needs to know the home network capabilities related to that task.

Steps 500 and 502 to 508 of FIG. 16 are as described earlier with reference to steps 400 and 404 to 410 of FIG. 15 respectively. However, in the embodiment illustrated in FIG. 16, it is the first NF node 10 that transmits the discovery request (at step 502 of FIG. 16) and receives the capability information, e.g. in the discovery response (at step 508 of FIG. 16).

Therefore, as illustrated in FIG. 16, new capabilities can be included in a profile at registration according to some embodiments. As illustrated by block 510 of FIG. 16, the capabilities of the home network are advantageously known by the first NF node 10.

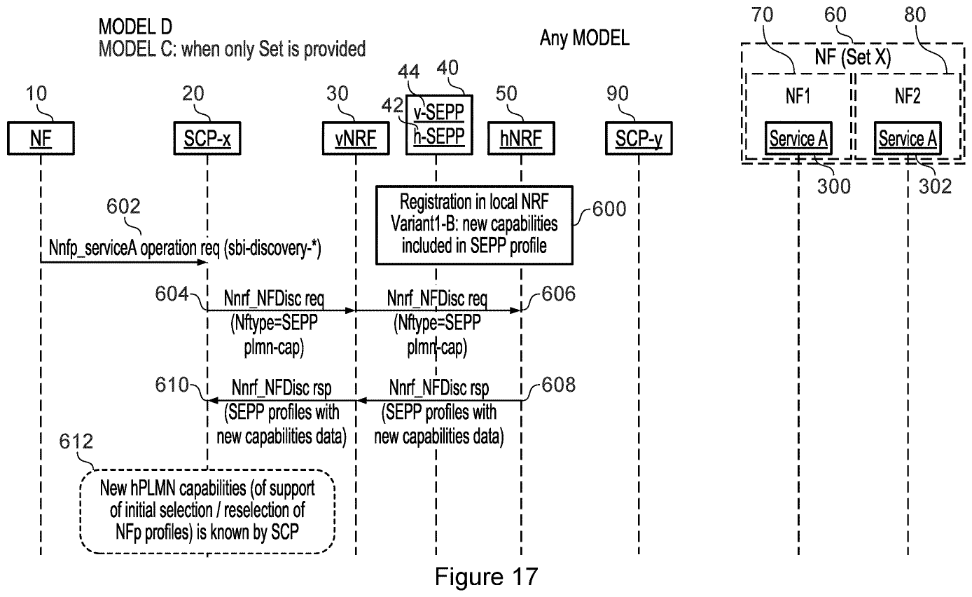

FIG. 17 is a signalling diagram illustrating an exchange of signals in a system according to an embodiment. This embodiment is an example of Variant 1 or, more specifically, Variant 1-B.

The system illustrated in FIG. 17 comprises a first SCP node 20 of a visited network (e.g. a visited PLMN) of a first NF node 10, a second NRF node 30 of the visited network, an SEPP node 40, a first NRF node 50 of a home network (e.g. a home PLMN) of the first NF node 10, and a plurality of second NF nodes 70, 80 of the home network. The SEPP node 40 comprises a first SEPP node 42 of the home network and a second SEPP node 44 of the visited network. The first SCP node 20 is configured to operate as an SCP between the first NF node 10 and the second NRF node 30 (and as an SCP between the first NF node 10 and the second SEPP node 44). The first SCP node 20, the second NRF node 30, the first SEPP node 42, the first NRF node 50, and the plurality of second NF nodes 70, 80 can be as described earlier with reference to FIGS. 2 to 11.

The system illustrated in FIG. 17 can also comprise the first NF node 10 and a second SCP node 90 of the home network. The second SCP node 90 can be configured to operate as an SCP between the first NRF node 50 and the plurality of second NF nodes 70, 80 (and as an SCP between the first SEPP node 42 and the plurality of second NF nodes 70, 80).

In the example illustrated in FIG. 17, the plurality of second NF nodes 70, 80 comprise two second NF nodes (i.e. “NF1” and “NF2”). However, it will be understood that the system illustrated in FIG. 17 can comprise one or more (i.e. any number of) second NF nodes. In the example illustrated in FIG. 17, a set of second NF nodes (“NF (Set X)”) comprises the plurality of second NF nodes 70, 80.

The exchange of signals between the nodes of the system illustrated in FIG. 17 will be described in terms of a service request. The plurality of second NF nodes 70, 80 can thus each be configured to provide a service 300, 302. Also, the first NF node 10 can be an NF node of a (service) consumer (NFc) and the plurality of second NF nodes can be a plurality of NF nodes of a (service) producer (NFps). However, it will be understood that other requests are also possible. For example, the service request of FIG. 17 may be replaced with a notification request. In some such examples, the first NF node 10 can be an NF node of a (service) producer (NFp) and the plurality of second NF nodes can be a plurality of NF nodes of a (service) consumer (NFcs).

As illustrated by block 600 of FIG. 17, the first SEPP node 42 provides information to the first NRF node 50 and thus the first NRF node 50 acquires the information. The information is indicative of whether the home network is capable of performing a task delegated to the home network from the visited network. Thus, the information may also be referred to herein as capability information.

In some embodiments, the capability information may be provided to the first NRF node 50 by registering an SEPP profile in the first NRF node 50. In these embodiments, the capability information can be included in the profile of the first SEPP node 42. For example, information about the support of the home network of (re)selection of NF capabilities may be included in such a profile.

Steps 602 to 606 of FIG. 17 are as described earlier with reference to steps 202 to 206 of FIG. 13 respectively.

In the embodiment illustrated in FIG. 17, at step 602, the first NF node 10 is configured to use indirect communication with Model D. As such, discovery parameters (e.g. sbi-discovery-*) can comprise information for an initial functional selection. If the first NF node 10 is instead configured to use indirect communication with Model C (with the variant where the first NF node 10 only provides the Set), then the discovery parameters (e.g. sbi-discovery-*) can comprise the NF Set. The NF Set is a set of second NF nodes from which one or more second NF nodes are to be selected.

In the embodiment illustrated in FIG. 17, at steps 604 and 606, in order for the first SCP node 20 to determine whether (re)selection of one or more second NF nodes needs to be delegated to the home network, the first SCP node 20 acquires the capability information using the NRF discovery service to obtain new data (e.g. named plmn-capabilities) included in the SEPP profile.

Steps 608 and 610 of FIG. 17 are as described earlier with reference to steps 408 and 410 of FIG. 15 respectively, except that the discovery response can comprise the acquired SEPP profile, rather than acquired NF profile(s). For example, in some embodiments, the discovery results can comprise an SEPP profile and that SEPP profile may comprise the capability information.

Therefore, as illustrated in FIG. 17, new capabilities can be included in an SEPP profile at registration according to some embodiments. As illustrated by block 612 of FIG. 17, the capabilities of the home network are advantageously known by the first SCP node 20.

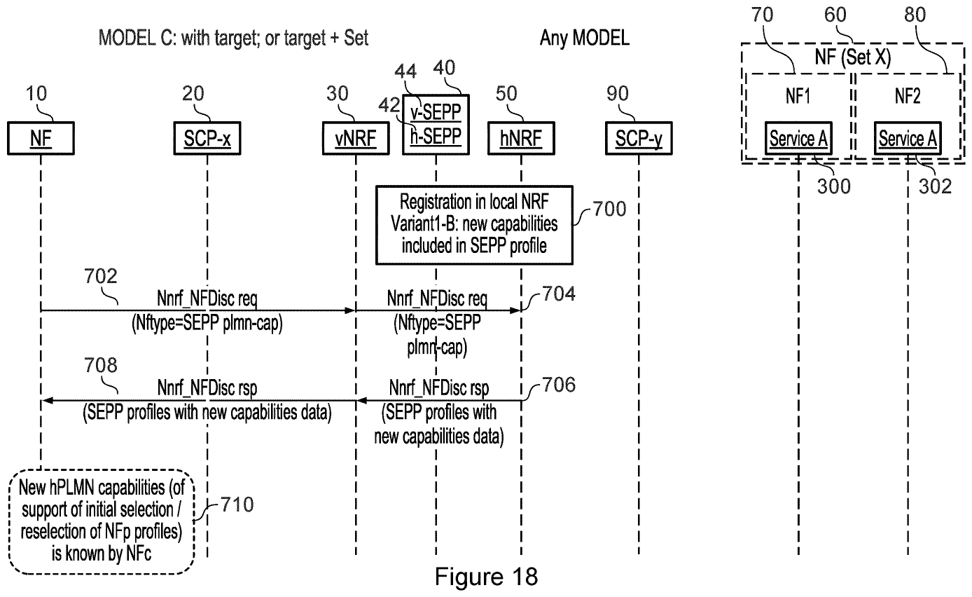

FIG. 18 is a signalling diagram illustrating an exchange of signals in a system according to an embodiment. This embodiment is an example of Variant 1 or, more specifically, Variant 1-B.

The system illustrated in FIG. 18 comprises a first SCP node 20 of a visited network (e.g. a visited PLMN) of a first NF node 10, a second NRF node 30 of the visited network, an SEPP node 40, a first NRF node 50 of a home network (e.g. a home PLMN) of the first NF node 10, and a plurality of second NF nodes 70, 80 of the home network. The SEPP node 40 comprises a first SEPP node 42 of the home network and a second SEPP node 44 of the visited network. The first SCP node 20 is configured to operate as an SCP between the first NF node 10 and the second NRF node 30 (and as an SCP between the first NF node 10 and the second SEPP node 44). The first SCP node 20, the second NRF node 30, the first SEPP node 42, the first NRF node 50, and the plurality of second NF nodes 70, 80 can be as described earlier with reference to FIGS. 2 to 11.

The system illustrated in FIG. 18 can also comprise the first NF node 10 and a second SCP node 90 of the home network. The second SCP node 90 can be configured to operate as an SCP between the first NRF node 50 and the plurality of second NF nodes 70, 80 (and as an SCP between the first SEPP node 42 and the plurality of second NF nodes 70, 80).

In the example illustrated in FIG. 18, the plurality of second NF nodes 70, 80 comprise two second NF nodes (i.e. “NF1” and “NF2”). However, it will be understood that the system illustrated in FIG. 18 can comprise one or more (i.e. any number of) second NF nodes. In the example illustrated in FIG. 18, a set of second NF nodes (“NF (Set X)”) comprises the plurality of second NF nodes 70, 80.

The exchange of signals between the nodes of the system illustrated in FIG. 18 will be described in terms of a service request. The plurality of second NF nodes 70, 80 can thus each be configured to provide a service 300, 302. Also, the first NF node 10 can be an NF node of a (service) consumer (NFc) and the plurality of second NF nodes can be a plurality of NF nodes of a (service) producer (NFps). However, it will be understood that other requests are also possible. For example, the service request of FIG. 18 may be replaced with a notification request. In some such examples, the first NF node 10 can be an NF node of a (service) producer (NFp) and the plurality of second NF nodes can be a plurality of NF nodes of a (service) consumer (NFcs).

FIG. 18 is similar to FIG. 17, except that FIG. 18 corresponds to an embodiment where indirect communication in the visited network follows Model C with target or Model C with target+Set. Model C with target is where the first NF node 10 includes a target destination (e.g. 3gpp-Sbi-Target-apiRoot) in a request, whereas Model C with target+Set is where the first NF node 10 includes a target destination (e.g. 3gpp-Sbi-Target-apiRoot) and an NF Set in a request. This request will be sent after step 710 of FIG. 18, from the first NF node 10 to the first SCP node 20. Prior to that, the first NF node 10 needs to know whether a task (e.g. (re)selection) may be delegated to the home network. That is, the first NF node 10 needs to know the home network capabilities related to that task.

Step 700 of FIG. 18 is as described earlier with reference to step 600 of FIG. 17. Steps 702 to 708 of FIG. 18 are as described earlier with reference to steps 604 to 610 of FIG. 17 respectively, except that it is the first NF node 10 that transmits the discovery request (at step 702 of FIG. 18) and receives the capability information, e.g. in the discovery response (at step 708 of FIG. 18). The discovery response can comprise the acquired SEPP profile, rather than acquired NF profile(s). For example, in some embodiments, the discovery results can comprise an SEPP profile and that SEPP profile may comprise the capability information.

Therefore, as illustrated in FIG. 18, new capabilities can be included in an SEPP profile at registration according to some embodiments. As illustrated by block 710 of FIG. 18, the capabilities of the home network are advantageously known by the first SCP node 20.

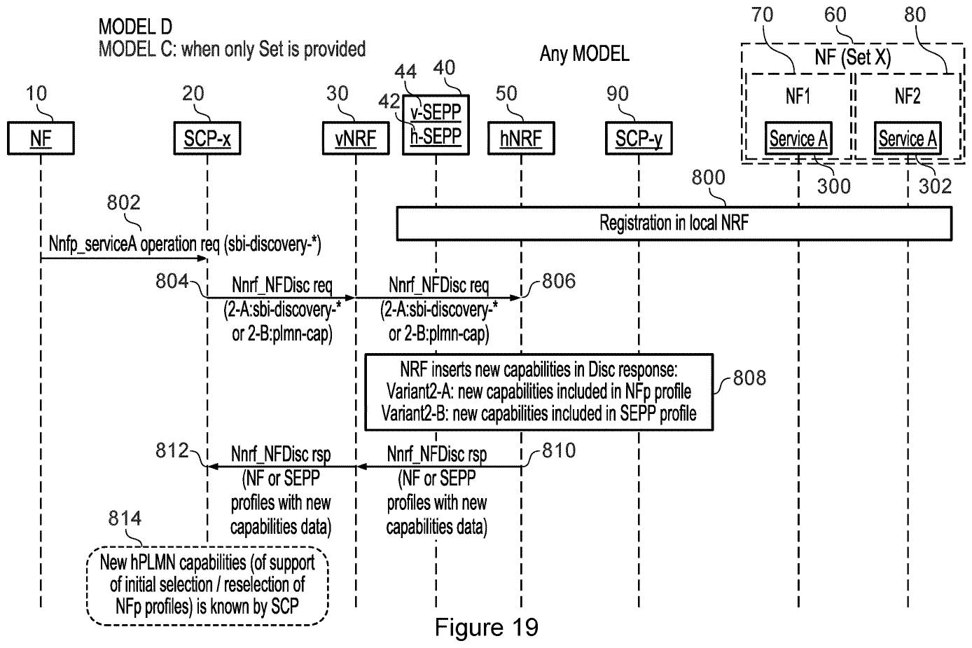

FIG. 19 is a signalling diagram illustrating an exchange of signals in a system according to an embodiment. This embodiment is an example of Variant 2.

The system illustrated in FIG. 19 comprises a first SCP node 20 of a visited network (e.g. a visited PLMN) of a first NF node 10, a second NRF node 30 of the visited network, an SEPP node 40, a first NRF node 50 of a home network (e.g. a home PLMN) of the first NF node 10, and a plurality of second NF nodes 70, 80 of the home network. The SEPP node 40 comprises a first SEPP node 42 of the home network and a second SEPP node 44 of the visited network. The first SCP node 20 is configured to operate as an SCP between the first NF node 10 and the second NRF node 30 (and as an SCP between the first NF node 10 and the second SEPP node 44). The first SCP node 20, the second NRF node 30, the first SEPP node 42, the first NRF node 50, and the plurality of second NF nodes 70, 80 can be as described earlier with reference to FIGS. 2 to 11.

The system illustrated in FIG. 19 can also comprise the first NF node 10 and a second SCP node 90 of the home network. The second SCP node 90 can be configured to operate as an SCP between the first NRF node 50 and the plurality of second NF nodes 70, 80 (and as an SCP between the first SEPP node 42 and the plurality of second NF nodes 70, 80).

In the example illustrated in FIG. 19, the plurality of second NF nodes 70, 80 comprise two second NF nodes (i.e. “NF1” and “NF2”). However, it will be understood that the system illustrated in FIG. 19 can comprise one or more (i.e. any number of) second NF nodes. In the example illustrated in FIG. 19, a set of second NF nodes (“NF (Set X)”) comprises the plurality of second NF nodes 70, 80.

The exchange of signals between the nodes of the system illustrated in FIG. 19 will be described in terms of a service request. The plurality of second NF nodes 70, 80 can thus each be configured to provide a service 300, 302. Also, the first NF node 10 can be an NF node of a (service) consumer (NFc) and the plurality of second NF nodes can be a plurality of NF nodes of a (service) producer (NFps). However, it will be understood that other requests are also possible. For example, the service request of FIG. 19 may be replaced with a notification request. In some such examples, the first NF node 10 can be an NF node of a (service) producer (NFp) and the plurality of second NF nodes can be a plurality of NF nodes of a (service) consumer (NFcs).

Step 800 of FIG. 800 of FIG. 19 is as described earlier with reference to step 400 of FIG. 15. Steps 802 to 806 of FIG. 19 are as described earlier with reference to steps 402 to 406 of FIG. 15 respectively and steps 602 to 606 of FIG. 17 respectively. As illustrated by block 808 of FIG. 19, the first NRF node 50 can insert the capability information into the discovery response. For example, the capability information may be included in NF profile(s) and/or an SEPP profile in the discovery response.

Steps 810 and 812 of FIG. 19 are as described earlier with reference to steps 408 and 410 of FIG. 15 respectively and steps 608 and 610 of FIG. 17 respectively, except that the discovery response can comprise the acquired NF profile(s) and/or the SEPP profile. For example, in some embodiments, the discovery results can comprise NF profile(s) and/or an SEPP profile, which may comprise the capability information. Thus, the first NRF node 50 can insert new capabilities in the discovery response.

Therefore, as illustrated in FIG. 19, new capabilities can be included in one or more NF profiles and/or an SEPP profile at registration according to some embodiments. As illustrated by block 814 of FIG. 19, the capabilities of the home network are advantageously known by the first SCP node 20.

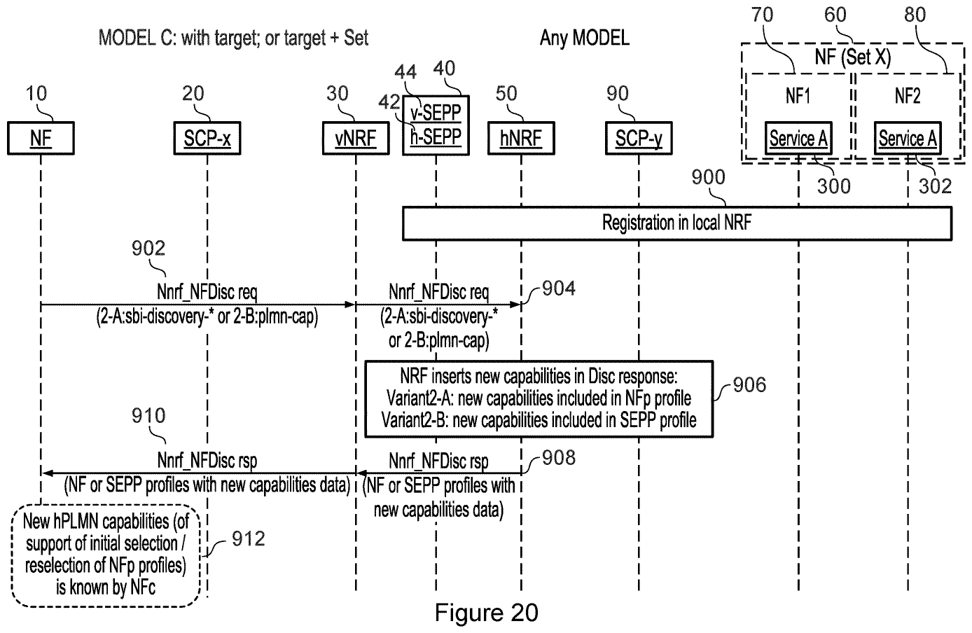

FIG. 20 is a signalling diagram illustrating an exchange of signals in a system according to an embodiment. This embodiment is an example of Variant 2.

The system illustrated in FIG. 20 comprises a first SCP node 20 of a visited network (e.g. a visited PLMN) of a first NF node 10, a second NRF node 30 of the visited network, an SEPP node 40, a first NRF node 50 of a home network (e.g. a home PLMN) of the first NF node 10, and a plurality of second NF nodes 70, 80 of the home network. The SEPP node 40 comprises a first SEPP node 42 of the home network and a second SEPP node 44 of the visited network. The first SCP node 20 is configured to operate as an SCP between the first NF node 10 and the second NRF node 30 (and as an SCP between the first NF node 10 and the second SEPP node 44). The first SCP node 20, the second NRF node 30, the first SEPP node 42, the first NRF node 50, and the plurality of second NF nodes 70, 80 can be as described earlier with reference to FIGS. 2 to 11.

The system illustrated in FIG. 20 can also comprise the first NF node 10 and a second SCP node 90 of the home network. The second SCP node 90 can be configured to operate as an SCP between the first NRF node 50 and the plurality of second NF nodes 70, 80 (and as an SCP between the first SEPP node 42 and the plurality of second NF nodes 70, 80).

In the example illustrated in FIG. 20, the plurality of second NF nodes 70, 80 comprise two second NF nodes (i.e. “NF1” and “NF2”). However, it will be understood that the system illustrated in FIG. 20 can comprise one or more (i.e. any number of) second NF nodes. In the example illustrated in FIG. 20, a set of second NF nodes (“NF (Set X)”) comprises the plurality of second NF nodes 70, 80.

The exchange of signals between the nodes of the system illustrated in FIG. 20 will be described in terms of a service request. The plurality of second NF nodes 70, 80 can thus each be configured to provide a service 300, 302. Also, the first NF node 10 can be an NF node of a (service) consumer (NFc) and the plurality of second NF nodes can be a plurality of NF nodes of a (service) producer (NFps). However, it will be understood that other requests are also possible. For example, the service request of FIG. 20 may be replaced with a notification request. In some such examples, the first NF node 10 can be an NF node of a (service) producer (NFp) and the plurality of second NF nodes can be a plurality of NF nodes of a (service) consumer (NFcs).

FIG. 20 is similar to FIG. 19, except that FIG. 20 corresponds to an embodiment where indirect communication in the visited network follows Model C with target or Model C with target+Set. Model C with target is where the first NF node 10 includes a target destination (e.g. 3gpp-Sbi-Target-apiRoot) in a request, whereas Model C with target+Set is where the first NF node 10 includes a target destination (e.g. 3gpp-Sbi-Target-apiRoot) and an NF Set in a request. This request will be sent after step 912 of FIG. 20, from the first NF node 10 to the first SCP node 20. Prior to that, the first NF node 10 needs to know whether a task (e.g. (re)selection) may be delegated to the home network. That is, the first NF node 10 needs to know the home network capabilities related to that task.

Step 900 of FIG. 20 is as described earlier with reference to step 800 of FIG. 19. Steps 902, 904, 908 and 910 of FIG. 20 are as described earlier with reference to steps 702, 704, 706 and 708 of FIG. 18 respectively, except that the discovery response can comprise the acquired NF profile(s) and/or SEPP profile. For example, in some embodiments, the discovery results can comprise NF profile(s) and/or an SEPP profile, which may comprise the capability information. Step 906 of FIG. 20 is as described earlier with reference to step 808 of FIG. 19.

Therefore, as illustrated in FIG. 20, new capabilities can be included in one or more NF profiles and an SEPP profile at registration according to some embodiments. As illustrated by block 912 of FIG. 20, the capabilities of the home network are advantageously known by the first SCP node 20.

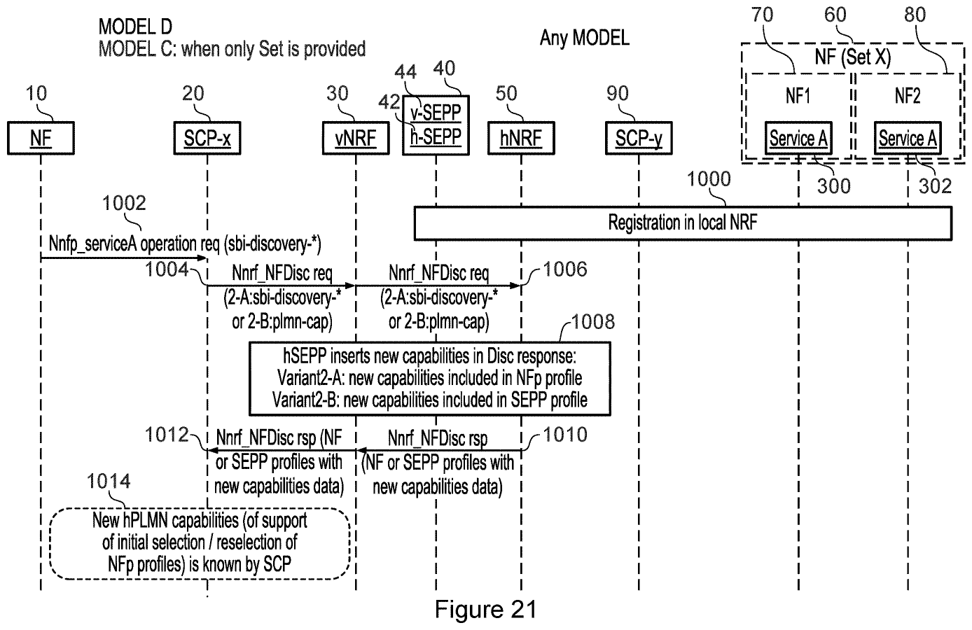

FIG. 21 is a signalling diagram illustrating an exchange of signals in a system according to an embodiment. This embodiment is an example of Variant 3.

The system illustrated in FIG. 21 comprises a first SCP node 20 of a visited network (e.g. a visited PLMN) of a first NF node 10, a second NRF node 30 of the visited network, an SEPP node 40, a first NRF node 50 of a home network (e.g. a home PLMN) of the first NF node 10, and a plurality of second NF nodes 70, 80 of the home network. The SEPP node 40 comprises a first SEPP node 42 of the home network and a second SEPP node 44 of the visited network. The first SCP node 20 is configured to operate as an SCP between the first NF node 10 and the second NRF node 30 (and as an SCP between the first NF node 10 and the second SEPP node 44). The first SCP node 20, the second NRF node 30, the first SEPP node 42, the first NRF node 50, and the plurality of second NF nodes 70, 80 can be as described earlier with reference to FIGS. 2 to 11.

The system illustrated in FIG. 21 can also comprise the first NF node 10 and a second SCP node 90 of the home network. The second SCP node 90 can be configured to operate as an SCP between the first NRF node 50 and the plurality of second NF nodes 70, 80 (and as an SCP between the first SEPP node 42 and the plurality of second NF nodes 70, 80).

In the example illustrated in FIG. 21, the plurality of second NF nodes 70, 80 comprise two second NF nodes (i.e. “NF1” and “NF2”). However, it will be understood that the system illustrated in FIG. 21 can comprise one or more (i.e. any number of) second NF nodes. In the example illustrated in FIG. 21, a set of second NF nodes (“NF (Set X)”) comprises the plurality of second NF nodes 70, 80.

The exchange of signals between the nodes of the system illustrated in FIG. 21 will be described in terms of a service request. The plurality of second NF nodes 70, 80 can thus each be configured to provide a service 300, 302. Also, the first NF node 10 can be an NF node of a (service) consumer (NFc) and the plurality of second NF nodes can be a plurality of NF nodes of a (service) producer (NFps). However, it will be understood that other requests are also possible. For example, the service request of FIG. 21 may be replaced with a notification request. In some such examples, the first NF node 10 can be an NF node of a (service) producer (NFp) and the plurality of second NF nodes can be a plurality of NF nodes of a (service) consumer (NFcs).

Step 1000 of FIG. 21 is as described earlier with reference to step 800 of FIG. 19. Steps 1002 to 1006 and 1010 to 1012 of FIG. 21 are as described earlier with reference to steps 802 to 806 and 810 to 812 of FIG. 19 respectively. Step 1008 of FIG. 21 is as described earlier with reference to step 808 of FIG. 19, except that step 1008 of FIG. 21 (i.e. the step of inserting the new capability information into the discovery response) is performed by the first SEPP node 42.

Therefore, as illustrated in FIG. 21, new capabilities can be included in one or more NF profiles and an SEPP profile at registration according to some embodiments. As illustrated by block 1014 of FIG. 21, the capabilities of the home network are advantageously known by the first SCP node 20.

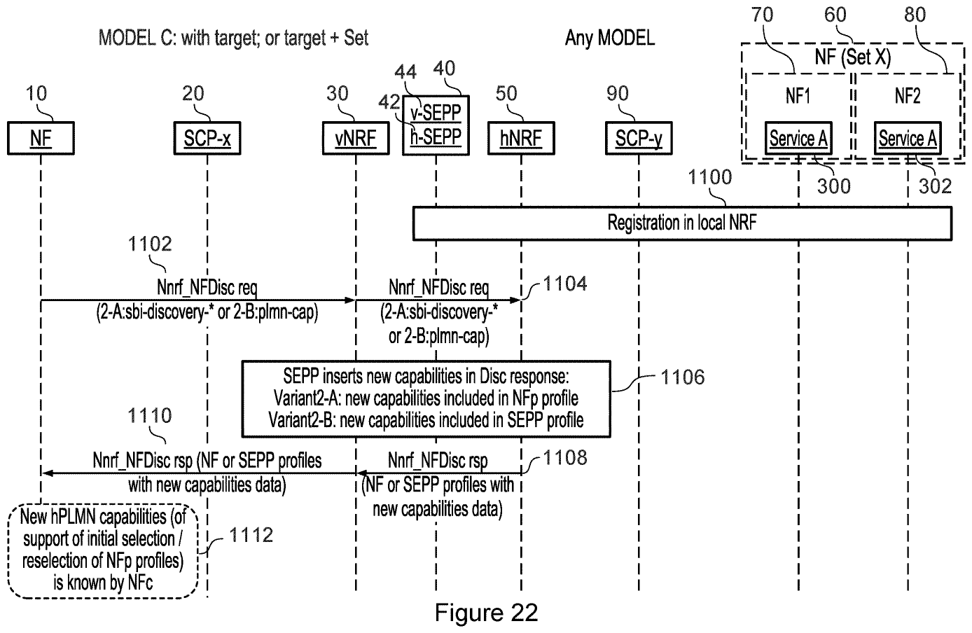

FIG. 22 is a signalling diagram illustrating an exchange of signals in a system according to an embodiment. This embodiment is an example of Variant 3.

The system illustrated in FIG. 22 comprises a first SCP node 20 of a visited network (e.g. a visited PLMN) of a first NF node 10, a second NRF node 30 of the visited network, an SEPP node 40, a first NRF node 50 of a home network (e.g. a home PLMN) of the first NF node 10, and a plurality of second NF nodes 70, 80 of the home network. The SEPP node 40 comprises a first SEPP node 42 of the home network and a second SEPP node 44 of the visited network. The first SCP node 20 is configured to operate as an SCP between the first NF node 10 and the second NRF node 30 (and as an SCP between the first NF node 10 and the second SEPP node 44). The first SCP node 20, the second NRF node 30, the first SEPP node 42, the first NRF node 50, and the plurality of second NF nodes 70, 80 can be as described earlier with reference to FIGS. 2 to 11.

The system illustrated in FIG. 22 can also comprise the first NF node 10 and a second SCP node 90 of the home network. The second SCP node 90 can be configured to operate as an SCP between the first NRF node 50 and the plurality of second NF nodes 70, 80 (and as an SCP between the first SEPP node 42 and the plurality of second NF nodes 70, 80).

In the example illustrated in FIG. 22, the plurality of second NF nodes 70, 80 comprise two second NF nodes (i.e. “NF1” and “NF2”). However, it will be understood that the system illustrated in FIG. 22 can comprise one or more (i.e. any number of) second NF nodes. In the example illustrated in FIG. 22, a set of second NF nodes (“NF (Set X)”) comprises the plurality of second NF nodes 70, 80.

The exchange of signals between the nodes of the system illustrated in FIG. 22 will be described in terms of a service request. The plurality of second NF nodes 70, 80 can thus each be configured to provide a service 300, 302. Also, the first NF node 10 can be an NF node of a (service) consumer (NFc) and the plurality of second NF nodes can be a plurality of NF nodes of a (service) producer (NFps). However, it will be understood that other requests are also possible. For example, the service request of FIG. 22 may be replaced with a notification request. In some such examples, the first NF node 10 can be an NF node of a (service) producer (NFp) and the plurality of second NF nodes can be a plurality of NF nodes of a (service) consumer (NFcs).

Step 1100 of FIG. 22 is as described earlier with reference to step 900 of FIG. 20. Steps 1102 to 1104 and 1108 to 1110 of FIG. 22 are as described earlier with reference to steps 902 to 904 and 908 to 910 of FIG. 20 respectively. Step 1106 of FIG. 22 is as described earlier with reference to step 906 of FIG. 20, except that step 1106 of FIG. 22 (i.e. the step of inserting the new capability information into the discovery response) is performed by the first SEPP node 42.

Therefore, as illustrated in FIG. 22, new capabilities can be included in one or more NF profiles and an SEPP profile at registration according to some embodiments. As illustrated by block 1112 of FIG. 22, the capabilities of the home network are advantageously known by the first NF node 10.

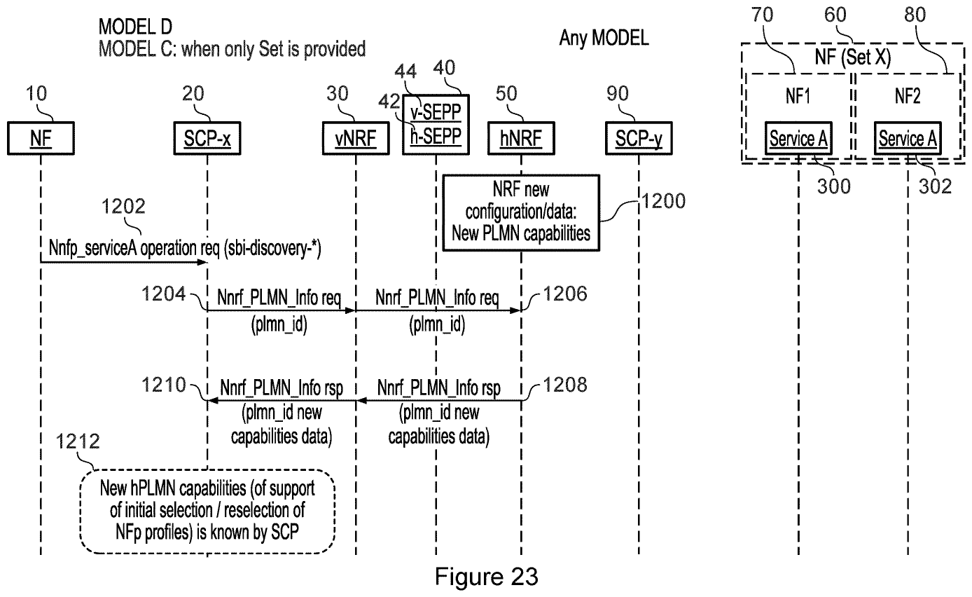

FIG. 23 is a signalling diagram illustrating an exchange of signals in a system according to an embodiment. This embodiment is an example of Variant 4.

The system illustrated in FIG. 23 comprises a first SCP node 20 of a visited network (e.g. a visited PLMN) of a first NF node 10, a second NRF node 30 of the visited network, an SEPP node 40, a first NRF node 50 of a home network (e.g. a home PLMN) of the first NF node 10, and a plurality of second NF nodes 70, 80 of the home network. The SEPP node 40 comprises a first SEPP node 42 of the home network and a second SEPP node 44 of the visited network. The first SCP node 20 is configured to operate as an SCP between the first NF node 10 and the second NRF node 30 (and as an SCP between the first NF node 10 and the second SEPP node 44). The first SCP node 20, the second NRF node 30, the first SEPP node 42, the first NRF node 50, and the plurality of second NF nodes 70, 80 can be as described earlier with reference to FIGS. 2 to 11.

The system illustrated in FIG. 23 can also comprise the first NF node 10 and a second SCP node 90 of the home network. The second SCP node 90 can be configured to operate as an SCP between the first NRF node 50 and the plurality of second NF nodes 70, 80 (and as an SCP between the first SEPP node 42 and the plurality of second NF nodes 70, 80).

In the example illustrated in FIG. 23, the plurality of second NF nodes 70, 80 comprise two second NF nodes (i.e. “NF1” and “NF2”). However, it will be understood that the system illustrated in FIG. 23 can comprise one or more (i.e. any number of) second NF nodes. In the example illustrated in FIG. 23, a set of second NF nodes (“NF (Set X)”) comprises the plurality of second NF nodes 70, 80.

The exchange of signals between the nodes of the system illustrated in FIG. 23 will be described in terms of a service request. The plurality of second NF nodes 70, 80 can thus each be configured to provide a service 300, 302. Also, the first NF node 10 can be an NF node of a (service) consumer (NFc) and the plurality of second NF nodes can be a plurality of NF nodes of a (service) producer (NFps). However, it will be understood that other requests are also possible. For example, the service request of FIG. 23 may be replaced with a notification request. In some such examples, the first NF node 10 can be an NF node of a (service) producer (NFp) and the plurality of second NF nodes can be a plurality of NF nodes of a (service) consumer (NFcs).

As illustrated by block 1200 of FIG. 23, the capability information is new data in the first NRF node 50. For example, the capability information may be stored in a memory of the first NRF node 50. Thus, the first NRF node 50 may acquire the capability information from its memory.

Step 1202 of FIG. 23 is as described earlier with reference to step 402 of FIG. 15.

As illustrated by arrow 1204 of FIG. 23, the first SCP node 20 transmits a request for the capabilities information towards the second NRF node 30. The second NRF node 30 thus receives the request from the first SCP node 20. As illustrated by arrow 1206 of FIG. 23, the second NRF node 30 transmits the request towards the first NRF node 50 via the SEPP node 40 (i.e. via the second SEPP node 44 and the first SEPP node 42). The first NRF node 50 thus receives the request from the first SCP node 20.

As illustrated by arrow 1208 of FIG. 23, the first NRF node 50 transmits a response towards the second NRF node 30 via the SEPP node 40 (i.e. via the first SEPP node 42 and the second SEPP node 44). The second NRF node 30 thus receives the response from the first NRF node 50. As illustrated by arrow 1210 of FIG. 23, the second NRF node 30 transmits the response towards the first SCP node 20. The first SCP node 20 thus receives the response from the second NRF node 30. The response comprises the capability information. The new service in the first NRF node 50 provides the new capability information. In some embodiments, the new capability information may be provided with a specific network identifier e.g. (plmn-id).

Therefore, as illustrated in FIG. 23, new capabilities can be provided by a new NRF service according to some embodiments. As illustrated by block 1212 of FIG. 23, the capabilities of the home network are advantageously known by the first SCP node 20.

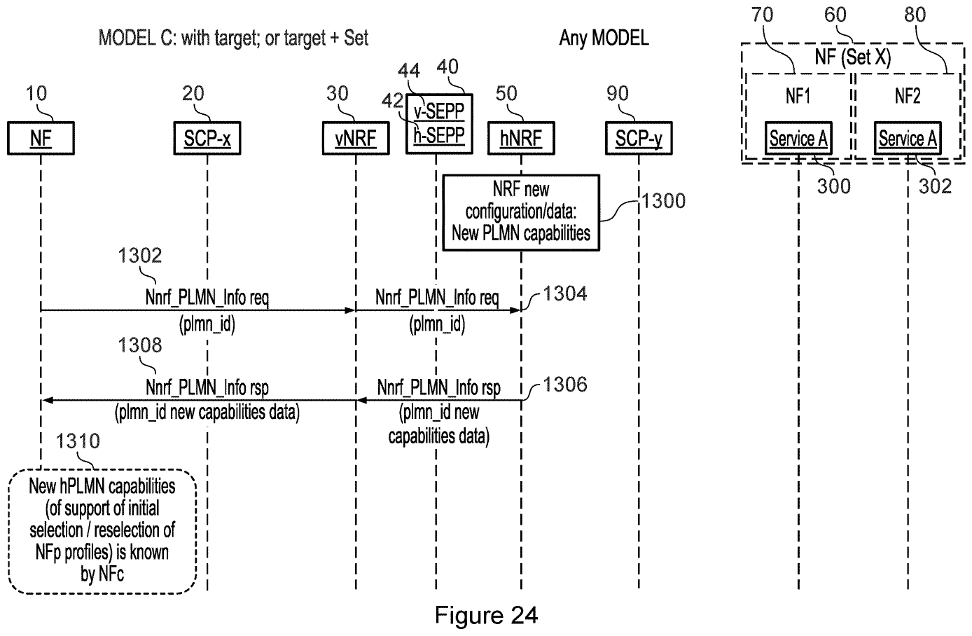

FIG. 24 is a signalling diagram illustrating an exchange of signals in a system according to an embodiment. This embodiment is an example of Variant 4.

The system illustrated in FIG. 24 comprises a first SCP node 20 of a visited network (e.g. a visited PLMN) of a first NF node 10, a second NRF node 30 of the visited network, an SEPP node 40, a first NRF node 50 of a home network (e.g. a home PLMN) of the first NF node 10, and a plurality of second NF nodes 70, 80 of the home network. The SEPP node 40 comprises a first SEPP node 42 of the home network and a second SEPP node 44 of the visited network. The first SCP node 20 is configured to operate as an SCP between the first NF node 10 and the second NRF node 30 (and as an SCP between the first NF node 10 and the second SEPP node 44). The first SCP node 20, the second NRF node 30, the first SEPP node 42, the first NRF node 50, and the plurality of second NF nodes 70, 80 can be as described earlier with reference to FIGS. 2 to 11.

The system illustrated in FIG. 24 can also comprise the first NF node 10 and a second SCP node 90 of the home network. The second SCP node 90 can be configured to operate as an SCP between the first NRF node 50 and the plurality of second NF nodes 70, 80 (and as an SCP between the first SEPP node 42 and the plurality of second NF nodes 70, 80).

In the example illustrated in FIG. 24, the plurality of second NF nodes 70, 80 comprise two second NF nodes (i.e. “NF1” and “NF2”). However, it will be understood that the system illustrated in FIG. 24 can comprise one or more (i.e. any number of) second NF nodes. In the example illustrated in FIG. 24, a set of second NF nodes (“NF (Set X)”) comprises the plurality of second NF nodes 70, 80.

The exchange of signals between the nodes of the system illustrated in FIG. 24 will be described in terms of a service request. The plurality of second NF nodes 70, 80 can thus each be configured to provide a service 300, 302. Also, the first NF node 10 can be an NF node of a (service) consumer (NFc) and the plurality of second NF nodes can be a plurality of NF nodes of a (service) producer (NFps). However, it will be understood that other requests are also possible. For example, the service request of FIG. 24 may be replaced with a notification request. In some such examples, the first NF node 10 can be an NF node of a (service) producer (NFp) and the plurality of second NF nodes can be a plurality of NF nodes of a (service) consumer (NFcs).

FIG. 24 is similar to FIG. 23, except that FIG. 24 corresponds to an embodiment where indirect communication in the visited network follows Model C with target or Model C with target+Set. Model C with target is where the first NF node 10 includes a target destination (e.g. 3gpp-Sbi-Target-apiRoot) in a request, whereas Model C with target+Set is where the first NF node 10 includes a target destination (e.g. 3gpp-Sbi-Target-apiRoot) and an NF Set in a request.

Step 1300 of FIG. 24 is as described earlier with reference to step 1200 of FIG. 23. Steps 1302 to 1308 of FIG. 24 are as described earlier with reference to steps 1204 to 1210 of FIG. 23 respectively. However, in the embodiment illustrated in FIG. 24, it is the first NF node 10 that transmits the request (at step 1302 of FIG. 24) and receives the capability information, e.g. in the response (at step 1308 of FIG. 24).

Therefore, as illustrated in FIG. 24, new capabilities can be provided by a new NRF service according to some embodiments. As illustrated by block 1310 of FIG. 24, the capabilities of the home network are advantageously known by the first NF node 10.

The wireless device referred to herein can be any type of wireless device. Examples of a type of wireless device as referred to herein include, but are not limited to, a user equipment (UE), such as a smart phone, a mobile phone, a cell phone, a voice over IP (VolP) phone, a wireless local loop phone, a desktop computer, a personal digital assistant (PDA), a wireless camera, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. The wireless device as referred to herein may support device-to-device (D2D) communication, for example, by implementing a third generation partnership project (3GPP) standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (loT) scenario, the wireless device as referred to herein may represent a machine or other device that performs monitoring and/or measurements, and transmits the results of such monitoring and/or measurements to another wireless device and/or a network node. The wireless device as referred to herein may in this case be a machine-to-machine (M2M) device, which may in a 3GPP context be referred to as a machine type communication (MTC) device.

As one particular example, the wireless device as referred to herein may be a user equipment (UE), e.g. implementing the 3GPP narrow band internet of things (NB-IoT) standard. Particular examples of such machines or devices are sensors, metering devices such as power meters, industrial machinery, or home or personal appliances (e.g. refrigerators, televisions, etc), personal wearables (e.g. watches, fitness trackers, etc). In other scenarios, the wireless device as referred to herein may represent a vehicle or other equipment that is capable of monitoring and/or reporting on its operational status or other functions associated with its operation. The wireless device as referred to herein may represent the endpoint of a wireless connection, in which case the wireless device as referred to herein may be referred to as a wireless terminal. Furthermore, the wireless device as referred to herein may be mobile, in which case it may also be referred to as a mobile device or a mobile terminal.

There is also provided a computer program comprising instructions which, when executed by processing circuitry (such as the processing circuitry 52 of the first NRF node 50 described earlier, the processing circuitry 32 of the second NRF node 30 described earlier, the processing circuitry 12 of the first network node 10, 20 described earlier, and/or the processing circuitry 72 of the second network node 42, 70, 80 described earlier), cause the processing circuitry to perform at least part of the method described herein. There is provided a computer program product, embodied on a non-transitory machine-readable medium, comprising instructions which are executable by processing circuitry (such as the processing circuitry 52 of the first NRF node 50 described earlier, the processing circuitry 32 of the second NRF node 30 described earlier, the processing circuitry 12 of the first network node 10, 20 described earlier, and/or the processing circuitry 72 of the second network node 42, 70, 80 described earlier) to cause the processing circuitry to perform at least part of the method described herein. There is provided a computer program product comprising a carrier containing instructions for causing processing circuitry (such as the processing circuitry 52 of the first NRF node 50 described earlier, the processing circuitry 32 of the second NRF node 30 described earlier, the processing circuitry 12 of the first network node 10, 20 described earlier, and/or the processing circuitry 72 of the second network node 42, 70, 80 described earlier) to perform at least part of the method described herein. In some embodiments, the carrier can be any one of an electronic signal, an optical signal, an electromagnetic signal, an electrical signal, a radio signal, a microwave signal, or a computer-readable storage medium.

In some embodiments, the node functionality described herein can be performed by hardware. Thus, in some embodiments, any one or more of the first NRF node 50 described herein, the second NRF node 30 described herein, the first network node 10, 20 described herein, and/or the second network node 42, 70, 80 described herein can be a hardware node. However, it will also be understood that optionally at least part or all of the node functionality described herein can be virtualized. For example, the functions performed by any one or more of the first NRF node 50 described herein, the second NRF node 30 described herein, the first network node 10, 20 described herein, and/or the second network node 42, 70, 80 described herein can be implemented in software running on generic hardware that is configured to orchestrate the node functionality. Thus, in some embodiments, any one or more of the first NRF node 50 described herein, the second NRF node 30 described herein, the first network node 10, 20 described herein, and/or the second network node 42, 70, 80 described herein can be a virtual node. In some embodiments, at least part or all of the node functionality described herein may be performed in a network enabled cloud. The node functionality described herein may all be at the same location or at least some of the node functionality may be distributed.

It will be understood that at least some or all of the method steps described herein can be automated in some embodiments. That is, in some embodiments, at least some or all of the method steps described herein can be performed automatically. The method described herein can be a computer-implemented method.

Thus, in the manner described herein, there is advantageously provided an improved technique for managing information exchange between networks. In particular, the technique described herein can provide the nodes of the network with knowledge of network capabilities. For example, capability information can be exchanged to allow a visited network of an NF node to acquire information about the capabilities of a home network of the NF node. This enables effective delegation of a task from the visited network to the home network. That is, the visited network is aware of the ability of the home network to perform a task delegated to the home network and thus errors associated with an inability to perform tasks in the home network are avoided. This is particularly useful in inter-network (from a visited network to a home network) communication, such as when an NF node is roaming.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for managing information exchange between networks, wherein the method is performed by a first network repository function, NRF, node, the method comprising:
providing information to a second NRF node, wherein a visited network of a first network function, NF, node comprises the second NRF node and a home network of the first NF node comprises the first NRF node, and
wherein the information is indicative of whether the home network is capable of performing a task delegated to the home network from the visited network.

2. The method as claimed in claim 1, wherein:
the information is provided in response to receiving a first message from the second NRF node.

3. The method as claimed in claim 2, wherein:
the first message comprises:
a first request that is a request for the information; and/or
a second request that is a request to discover one or more second NF nodes of the home network.

4. The method as claimed in claim 2, wherein:
the first message comprises an identifier that identifies the visited network.

5. The method as claimed in claim 1, wherein:
providing the information to the second NRF node comprises:
initiating transmission of a second message towards the second NRF node, wherein the second message comprises the information.

6. The method as claimed in claim 1, wherein:
the information is provided in a profile of a second NF node of the home network or a profile of a first security edge protection proxy, SEPP, node of the home network.

7. The method as claimed in claim 1, the method comprising:
storing the information at the first NRF node.

8. The method as claimed in claim 1, wherein:
the first NF node is an NF node of a consumer; or
the first NF node is an NF node of a producer.

9. The method as claimed in claim 1, wherein:
the task is to select one or more second NF nodes of the home network.

10. The method as claimed in claim 9, wherein:
the first NF node is an NF node of a consumer and the task is to select one or more second NF nodes, of a producer to provide a service requested by the first NF node; or
the first NF node is an NF node of a producer and the task is to select one or more second NF nodes of a consumer to provide a notification requested by the first NF node.

11. A method for managing information exchange between networks, wherein the method is performed by a second network repository function, NRF, node the method comprising:
acquiring information from a first NRF node wherein a home network of a first network function, NF, node comprises the first NRF node and a visited network of the first NF node comprises the second NRF node, and
wherein the information is indicative of whether the home network is capable of performing a task delegated to the home network from the visited network.

12. The method as claimed in claim 11, wherein:
the information is acquired in response to transmitting a first message towards the first NRF node.

13. The method as claimed in claim 12, wherein:
the first message comprises:
a first request that is a request for the information; and/or
a second request that is a request to discover one or more second NF nodes of the home network.

14. The method as claimed in claim 12, wherein:
the first message comprises an identifier that identifies the visited network.

15. The method as claimed in 11, wherein:
acquiring the information from the first NRF node comprises:
receiving a second message from the first NRF node, wherein the second message comprises the information.

16. The method as claimed in 11, wherein:
the information is acquired in a profile of a second NF node of the home network or a profile of a first security edge protection proxy, SEPP, node of the home network.

17. The method as claimed in 11, wherein:
the first NF node is an NF node of a consumer; or
the first NF node is an NF node of a producer.

18. The method as claimed in 11, wherein:
the task is to select one or more second NF nodes of the home network.

19. The method as claimed in claim 18, wherein:
the first NF node is an NF node of a consumer and the task is to select one or more second NF nodes, of a producer to provide a service requested by the first NF node or
the first NF node is an NF node of a producer and the task is to select one or more second NF nodes, of a consumer to provide a notification requested by the first NF node.

20. A method for managing information exchange between networks, wherein the method is performed by a second network repository function, NRF, node, the method comprising:
providing information to a first network node, wherein the first network node is a first network function, NF node or a first service communication proxy, SCP, node that is configured to operate as an SCP between the first NF node and the second NRF node, and a visited network of the first NF node comprises the second NRF node and the first network node, and
wherein the information is indicative of whether a home network of the first NF node is capable of performing a task delegated to the home network from the visited network.

21. The method as claimed in claim 20, wherein:
the information is provided in response to receiving a second message from a first NRF node, wherein the second message comprises the information.

22. The method as claimed in claim 20, wherein:
providing the information to the first network node comprises:
initiating transmission of a third message towards the first network node, wherein the third message comprises the information.

23.-26. (canceled)

27. A method for managing information exchange between networks, wherein the method is performed by a first network node the method comprising:
acquiring information from a second network repository function, NRF, node, wherein the first network node is a first network function, NF, node or a first service communication proxy, SCP, node that is configured to operate as an SCP between the first NF node and the second NRF node, and a visited network of the first NF node comprises the second NRF node and the first network node, and
wherein the information is indicative of whether a home network of the first NF node is capable of performing a task delegated to the home network from the visited network.

28.-38. (canceled)

39. A method for managing information exchange between networks, wherein the method is performed by a second network node the method comprising:
providing information to a first network repository function, NRF, node wherein the second network node is a second network function, NF, node or a first security edge protection proxy, SEPP, node and a home network of a first network function, NF, node comprises the second network node and the first NRF node, and
wherein the information is indicative of whether the home network is capable of performing a task delegated to the home network from a visited network of the first NF node.

40.-65. (canceled)
